(19) United States
(12) Patent Application Publication
(10) Pub. No.: US 2025/0014161 A1
(43) Pub. Date: Jan. 9, 2025

(54) BUILDING ENVELOPE REMOTE SENSING DRONE SYSTEM AND METHOD

(71) Applicants: GEORGIA TECH RESEARCH CORPORATION, Atlanta, GA (US); SYRACUSE UNIVERSITY, Syracuse, NY (US); MASSACHUSETTS INSTITUTE OF TECHNOLOGY, Cambridge, MA (US)

(72) Inventors: Tarek RAKHA, Atlanta, GA (US); Senem VELIPASALAR, Syracuse, NY (US); John FERNANDEZ, Cambridge, MA (US); Norhan BAYOMI, Cambridge, MA (US)

(21) Appl. No.: 18/711,826

(22) PCT Filed: Nov. 19, 2022
(86) PCT No.: PCT/US2022/050509

§ 371 Date: May 20, 2024

Related U.S. Application Data
(60) Provisional application No. 63/281,147, filed on Nov. 19, 2021.

(51) Int. Cl. G06T 7/00; G01J 5/00; G01J 5/10; G05D 1/689; G05D 105/80; G06T 7/33; G06T 7/73; G06V 10/75; G06V 10/764; G06V 20/10; G06V 20/17; G06V 20/64

(52) U.S. Cl. CPC G06T 7/0002; G01J 5/10; G05D 1/689; G06T 7/344; G06T 7/75; G06V 10/753; G06V 10/764; G06V 20/17; G06V 20/176; G06V 20/194; G06V 20/653; G01J 2005/0077; G05D 2105/89; G06T 2207/10032; G06T 2207/10048; G06T 2207/20076; G06T 2207/20212; G06T 2207/30184

(57) ABSTRACT

Exemplary methods, systems, apparatus, and computer programs are disclosed for an unmanned aerial system (UAS) inspection system that includes an unmanned aerial system and analysis system for exterior building envelopes and energy performance evaluation and simulation. The UAS can autonomously and systematically collect data for a building's exterior using a payload comprising (i) nondestructive testing (NDT) sensors configured for imaging (visible, infrared, or more) the building and (ii) one or more multi-spectral sensors (LiDAR, ultrasound, radar, or more). The acquired sensor data are provided to an analysis system comprising computer vision (CV) and signal processing modules configured to analyze the acquired data to i) identify building objects (doors, windows, rooftop units, and others) ii) characterize envelope properties (components, heat resistivity, or others) and 3) identify initial thermal anomalies (thermal bridges, physical defects, or infiltration/exfiltration) in a processing pipeline.

### RELATED APPLICATION

This PCT application claims priority to, and the benefit of, U.S. Patent Provisional Application No. 63/281,147, filed Nov. 19, 2021, entitled “BUILDING ENVELOPE REMOTE SENSING DRONES (BERD),” which is incorporated by reference herein in its entirety.

### GOVERNMENT SUPPORT CLAUSE

This invention was made with government support under Grant No. GR00001151 awarded by the U.S. Department of Energy. The government has certain rights in the invention.

### BACKGROUND

More than half of all U.S. residential and commercial buildings in operation today were built before 1980, and this large existing building stock, on average, performs with lower energy usage efficiency. Envelopes and windows can impact over 50% of the energy loads of the building structure, with up to 7.3 quads of energy use associated with the opaque envelope (roof, walls, and foundation), infiltration and window energy losses consuming more than 4 and 4.3 quads of residential and commercial building primary energy use, respectively.

While retrofitting practices to identify, diagnose, and design solutions that address issues of building usage, systems, and envelope are commonplace, the technical problems associated with the diagnostic processes include i) inaccessibility to areas such as roofs, ii) significantly time-consuming inspection activities, with the possibility of human error, and iii) unsafe and life-threatening settings for detailed inspection. These difficulties in the auditing process create challenges and do not inform retrofitting design decisions accurately when accounting for construction defects or degradation. Current retrofit BEM tools also are time-consuming and labor intensity due to the manual modeling of the building envelope and their calibration processes.

Drones and unmanned system technology have been employed to qualitatively assess large-scale areas. The use of such technology presents additional technical requirements that require these systems to fly in closer proximity to the building structure.

There is thus a benefit to examining building envelopes safely, accurately, and rapidly to automate the importing of building characteristic data into existing virtual audit and inspection platforms.

### SUMMARY

Exemplary methods, systems, apparatus, and computer programs are disclosed for an unmanned aerial system (UAS) inspection system that includes an unmanned aerial system and analysis system for exterior building envelopes and energy performance evaluation and simulation. In some embodiments, the UAS (e.g., configured as an internet-connected UAS) is configured to take off from a home point or location proximal to a building of interest to collect data autonomously and systematically for a building's exterior. The UAS includes a payload of (i) nondestructive testing (NDT) sensors configured for imaging (visible, infrared, or more) of the building and (ii) one or more multi-spectral sensors (LiDAR, ultrasound, radar, or more). The acquired sensor data are provided to an analysis system comprising modules for computer vision (CV) and signal processing to analyze the acquired data to i) identify building objects (doors, windows, rooftop units, and others) ii) characterize envelope properties (components, heat resistivity, or others) and 3) identify initial thermal anomalies (thermal bridges, physical defects, or infiltration/exfiltration) in a processing pipeline. In some embodiments, the operation may be performed in a processing pipeline in real-time.

To provide for a comprehensive sensor acquisition of the building envelope, the system can perform, following a computer-generated flight path, a first flight path that is followed by a second, more detailed, close-up inspection flight. The flight path may maintain (i) a pre-defined distance of the UAS from the building envelope or ground surface or (ii) a fixed elevation. The UAS can land after a comprehensive data collection. Post-processing of image data may be performed, e.g., using photogrammetry techniques to develop 3D Computer Aided Design (CAD) models that represent the building envelope. The analysis system is configured to identify and register defects digitally to the building model and translate the geometry of the envelope and the identified defects into both a 3D CAD model and a Building Information Model (BIM) for subsequent use in the inspection of the building structure. The analysis system is configured to employ Building Energy Modeling (BEM) operations to quantify the performance of the building using the registered geometric patches as the defects. The analysis system can employ or search BEM templates for identified building vintages for all inputs other than the envelope in which the complete building envelope profile may include identified objects, materials, defects, thermal properties, and others that can be simulated.

In an aspect, a system is disclosed for exterior building envelope inspection comprising: an unmanned aerial system (UAS); a payload comprising (i) first visual sensors configured for imaging of the building envelope and (ii) one or more second sensors for multi-spectral imaging; and a computer vision and signal processing system, the computer vision and signal processing system being configured via computer-readable instructions to (i) identify building objects within a three-dimensional model of the building envelope and (ii) determine envelope properties and location of thermal anomalies in the three-dimensional model.

In some embodiments, the computer vision and signal processing system are performed in a processing pipeline in real-time.

In some embodiments, the unmanned aerial system is configured via second computer-readable instructions with a preliminary flight path for a given building structure and then with instructions to perform a detailed close-up inspection flight of an identified location of thermal anomalies.

In some embodiments, the system further includes an analysis system configured to perform a photogrammetry analysis operation to generate the three-dimensional model of the building envelope.

In some embodiments, the analysis system is configured to register identified defects to the three-dimensional model.

In some embodiments, RGB image data of the one or more first visual sensors and IR image data of the one or more first visual sensors are combined by keypoint detection and matching.

In some embodiments, the aligned image data of the one or more first visual sensors are mapped, via a homographic transformation operation, to the three-dimensional model of the building envelope.

In some embodiments, the identified building objects are represented as coordinate data.

In some embodiments, the thermal anomalies are represented as coordinate data.

In some embodiments, the analysis system is configured to (i) generate polygonal objects of the coordinate data of the identified building objects and the thermal anomalies and (ii) register the polygonal objects to the three-dimensional model.

In some embodiments, the polygonal objects are assigned a thermal characteristic parameter different from that of the three-dimensional model.

In another aspect, a method is disclosed for exterior building envelope inspection, the method comprising: obtaining, by a processor, image data of an unmanned aerial system, wherein the image data are acquired from one or more first visual sensors of the unmanned aerial system; detecting objects, including doors and windows, within the obtained image data; identifying the detected objects via one or more classification operation; determining areas of the detected objects via a second classification operation; categorizing, via a search model, anomalies in the image data from the first visual sensors; and combining data of the categorized anomalies with data of the detected objects to quantify each anomaly's probability and class type, wherein the combined data are assigned a thermal characteristic parameter different from that of a three-dimensional model of the building envelope.

In some embodiments, the method further includes outputting an inspection report for exterior building envelope inspection.

In some embodiments, the image data of the one or more first visual sensors are combined by keypoint detection and matching.

In some embodiments, the aligned image data of the one or more first visual sensors are mapped, via a homographic transformation operation, to the three-dimensional model of the building envelope.

In some embodiments, the three-dimensional model of the building envelope is generated via a photogrammetry operation.

In some embodiments, the image data from the one or more first visual sensors are obtained via a first flight path of the unmanned aerial system, the unmanned aerial system comprising one or more second sensors for multi-spectral imaging to maintains a distance to the building envelope according to the first flight path.

In some embodiments, the image data from one or more first visual sensors are additionally obtained via a second flight path of the unmanned aerial system that maintains a constant elevation in a strip path flight path.

In another aspect, a non-transitory computer readable medium is disclosed having instructions thereon, wherein execution of the instructions by a processor cause the processor to: obtain image data of an unmanned aerial system, wherein the image data are acquired from one or more first visual sensors of the unmanned aerial system; detect objects, including doors and windows, within the obtained image data; identify the detected objects via one or more classification operation; determine areas of the detected objects via a second classification operation; categorize, via a search model, anomalies in the image data from the first visual sensors; and combine data of the categorized anomalies with data of the detected objects to quantify each anomaly's probability and class type, wherein the combined data are assigned a thermal characteristic parameter different from that of a three-dimensional model of the building envelope.

In some embodiments, the execution of the instructions by the processor further cause the processor to output an inspection report for exterior building envelope inspection.

In some embodiments, the image data of the one or more first visual sensors are combined by keypoint detection and matching.

In some embodiments, the aligned image data of the one or more first visual sensor are mapped, via a homographic transformation operation, to the three-dimensional model of the building envelope.

In some embodiments, the three-dimensional model of the building envelope is generated via a photogrammetry operation.

In some embodiments, the image data from the one or more first visual sensors are obtained via a first flight path of the unmanned aerial system, the unmanned aerial system comprising one or more second sensors for multi-spectral imaging to maintains a distance to the building envelope according to the first flight path.

In some embodiments, the image data from one or more first visual sensors are additionally obtained via a second flight path of the unmanned aerial system that maintains a constant elevation in a strip path flight path.

### BRIEF DESCRIPTION OF THE DRAWINGS

The skilled person in the art will understand that the drawings described below are for illustration purposes only.

FIGS. 1A, 1, and 1C each show an example Unmanned Aerial System (UAS) inspection system and corresponding building analysis system in accordance with an illustrative embodiment.

FIG. 2A shows an example method of operation of the unmanned aerial system inspection system in accordance with an illustrative embodiment.

FIG. 2B shows a method to identify and categorize anomalies in the image data from the first visual sensors in accordance with an illustrative embodiment.

FIG. 2C shows a method to combine the identified thermal detects or anomalies in the building model in accordance with an illustrative embodiment.

FIG. 3 shows example flight path trajectories for the UAS to acquire the sensor data for the inspection analysis in accordance with an illustrative embodiment.

FIGS. 4A, 4B, 4C, 4D, 4E, 4F, 4G, 4H, and 4I show example operations for structural envelope analysis, including object detection in the building envelope in accordance with an illustrative embodiment.

FIGS. 5A, 5B, 5C, and 5D show aspects for building envelope model generation and object registration in accordance with an illustrative embodiment.

FIGS. 6A and 6B show aspects of building envelope model generation in accordance with an illustrative embodiment.

FIG. 7A shows the registration of the building objects and anomalies in a building envelope energy model in accordance with an illustrative embodiment.

FIGS. 7B and 7C show a study comparing energy analysis results of different building envelope energy models.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the reference list. For example, Ref [1] refers to the 1^{st} reference in the list. All references cited and discussed in this specification are incorporated herein by reference in their entirety and to the same extent as if each reference was individually incorporated by reference.

### Example System #1

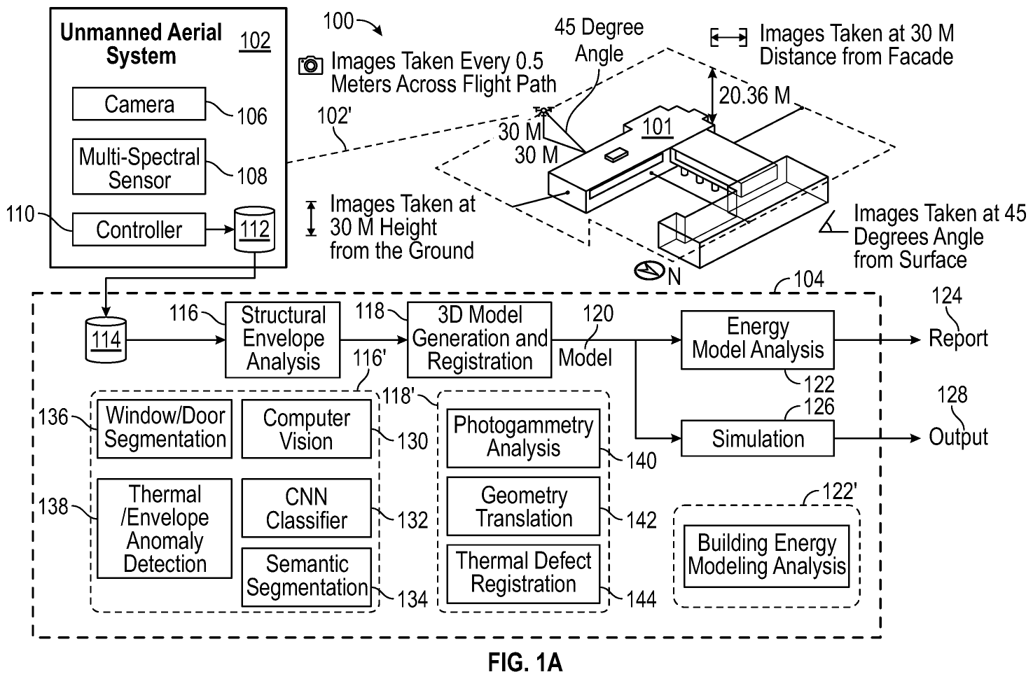

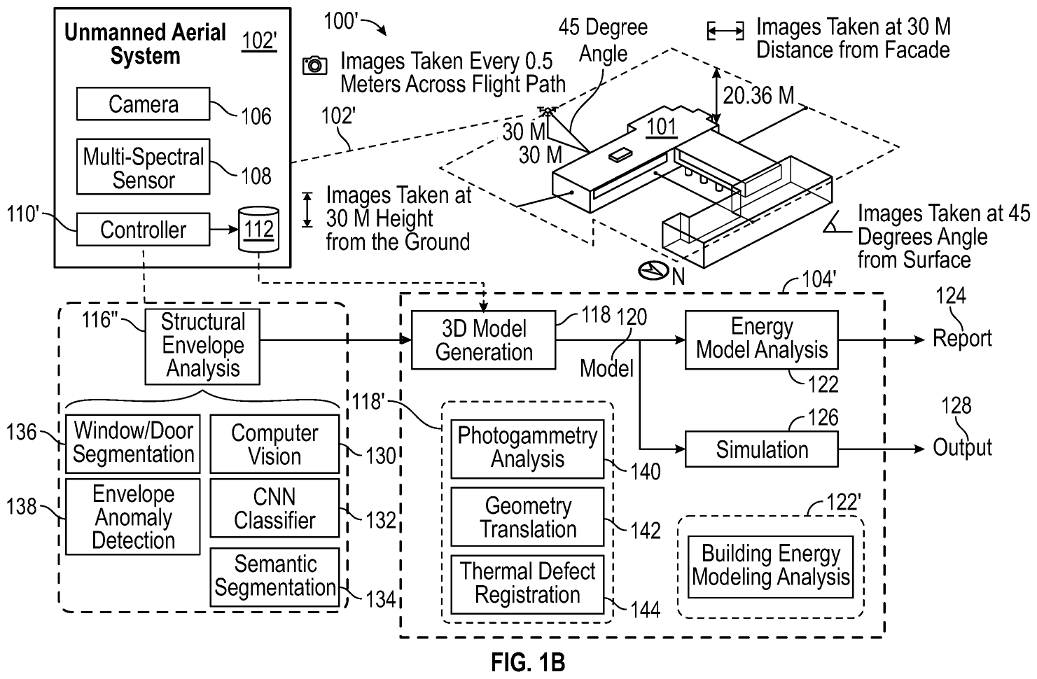

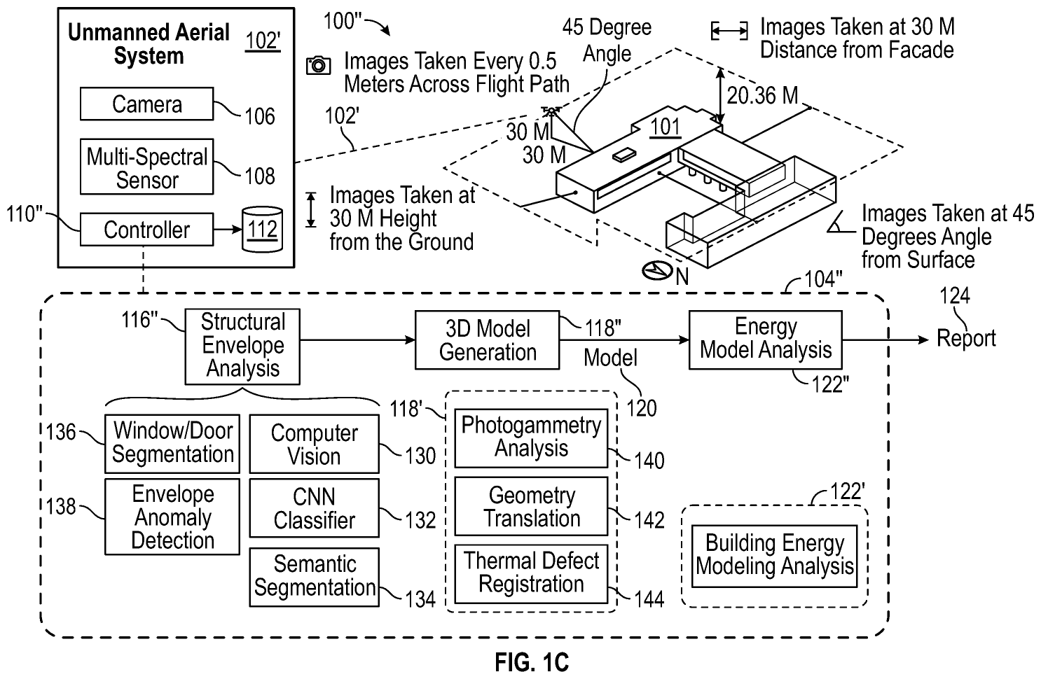

FIG. 1A shows an example unmanned aerial system (UAS) inspection system 100 comprising an unmanned aerial system 102 and corresponding building analysis system 104 in accordance with an illustrative embodiment. The unmanned aerial system 102 includes a first sensor 106 (shown as a “Camera” 106), a second sensor 108 (shown as a “Multi-Spectral Sensor” 108), and a controller 110.

The camera system 106 is configured to acquire images (e.g., visible images, infrared images, and/or video) of a structure or dwelling 101 to be used for the thermal analysis. The multi-spectral sensor 108 is configured to acquire multi-spectral images, e.g., LiDAR, ultrasound, or radar sensor, to be used for guidance of the UAS 102 around the structure.

The dual camera and multi-spectral sensor system 106, 108 can be employed to collectively acquire large-scale façade reference images (RIs) at a first distance from the building envelope and close-up RGB images and IR images at a second distance. The façade RIs, e.g., acquired 30 meters from the building envelope, can be used in the analysis as base maps in 3D building models for image registration. RGB and IR images, captured by flying a drone 102 (shown as 102′), e.g., at a fixed elevate, can provide close-up strip paths 2-10 meters from the façade surfaces, that can be used for detailed detection of façade defects or anomalies.

The controller 110 includes computer-executable instructions to operate the unmanned aerial system during the image and multi-spectral acquisition and to provide the flight plan of the unmanned aerial system during the building sensor and image acquisition. The data is stored in a local storage device 112. In some embodiments, the controller 110 is configured to transmit the data from the local storage device 112, or a storage buffer, through a network to a remote storage device 114, e.g., operatively located to or accessible by the analysis system 104.

The analysis system 104 includes a structural envelope analysis module 116 and a 3D model generation and registration module 118 that collectively output a computer model 120 of the building envelope. Model 120 can be employed in a subsequent analysis 122, e.g., comprising a thermal evaluation of the building envelope, to provide a report 124 of the same. Report 124 can include a thermal report employed in the inspection of a building, e.g., for retrofit, remodeling, zoning compliant, or purchase and sale. Model 120 may also be used in simulations of multiple building structures, e.g., for urban or city planning research or other large area analysis. Indeed, the inspection system 100 can provide a custom report or evaluation of a building in a systematic and autonomous manner that negates the need for or supplement manual inspection. System 100 provides a practical application for improving inspection accuracy, consistency, fidelity, and comprehensiveness, as well as having the potential to reduce the cost of the inspection.

The exemplary system (e.g., 100) can be characterized as a cyber-physical system that is configured to autonomously inspect and model building envelopes in a manner that is complete, accurate, safe, and rapid via the use of unmanned aerial systems (UAS), nondestructive testing (NDT) sensors, signal processing, computer vision (CV) and building energy modeling (BEM), among other examples described herein. The method provides a comprehensive framework of data collection, analytics, digitization, and simulation for remote building envelope data collection and diagnostics to inform energy retrofits of existing buildings. The exemplary system (e.g., 100), via measurements from equipped NDT sensors and onboard processing, can autonomously detect heat transfer anomalies and assess envelope material conditions swiftly and precisely using CV and Machine Learning (ML) techniques. The system can reduce the audit time for detailed envelope inspection by 60-75% (1-4 hours for a 100,000 sq. ft building) and generate a report in 1-3 days, which exhibits suggested retrofit savings of 5 to 30% on monthly utility bills for tested cases.

In the example shown in FIG. 1A, the structure envelope analysis 116 (shown as 116′ in further detail for an illustrative example) is configured to identify building objects such as doors, windows, rooftop units, and other structures employing a computer vision module 130, a machine learning based classifier 132 (shown as “CNN Classifier”), a semantic segmentation module 134, a window and/or door segmentation module 136, and a thermal/envelope anomaly detection module 138.

The 3D Model generation and registration module 118 (shown as 118′ in further detail in an illustrative example) are configured to generate a building envelope model from the acquired sensor data employing a photogrammetry analysis module 140, a geometry translation module 142, and a thermal defect registration module 144. It should be appreciated that various modules described herein can be implemented in other configurations to provide similar, if not the same, functionality for the application space.

### Example Systems #2 and #3

FIGS. 1B and 1C each shows additional examples of the unmanned aerial system (UAS) inspection system 100 (shown as 100′ and 100″ respectively) comprising the unmanned aerial system 102 (shown as 102′) and a building analysis system 104 (shown as 104′ and 104″, respectively) in accordance with another illustrative embodiment. The unmanned aerial system 102′ includes the camera system 106, the multi-spectral sensor 108, and the controller 110 in which the controller 110 (shown as 110′ and 110″, respectively) includes the instructions to execute a part of the analysis of identifying building objects (doors, windows, rooftop units, and others), characterizing envelope properties (components, heat resistivity, or others), and/or identifying thermal anomalies (thermal bridges, physical defects, or infiltration/exfiltration), e.g., as described in relation to FIG. 1A.

In the example shown in FIG. 1B, the structural envelope analysis 116″, or a portion thereof, may be executed by the controller 110.

In the example shown in FIG. 1C, the structural envelope analysis 116″, the 3D model generation analysis 118″, and the energy model analysis 122″ may be executed by the controller 110.

The analysis may be performed in real-time, e.g., in a processing pipeline during the operation of the UAS. In some embodiments, the processing is performed following the acquisition stage while the UAS is in a resting state. Real-time/on-site analysis can identify gaps or anomalies in the data acquisition that can be useful in informing additional on-site or manual inspection of locations identified in the anomalous regions. In the example of FIG. 1A, the data can be offloaded to an analysis system and performed while the UAS is still on-site.

### Example Methods of Operation

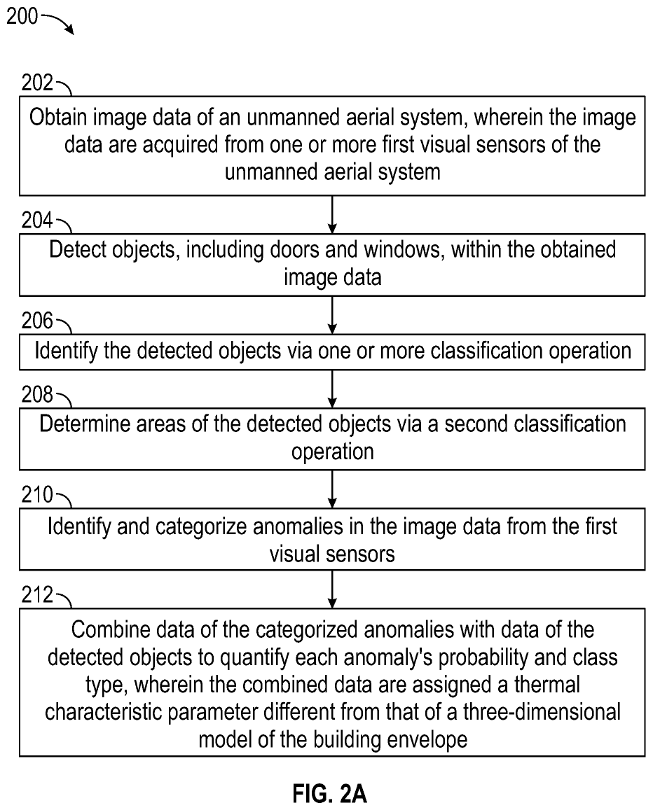

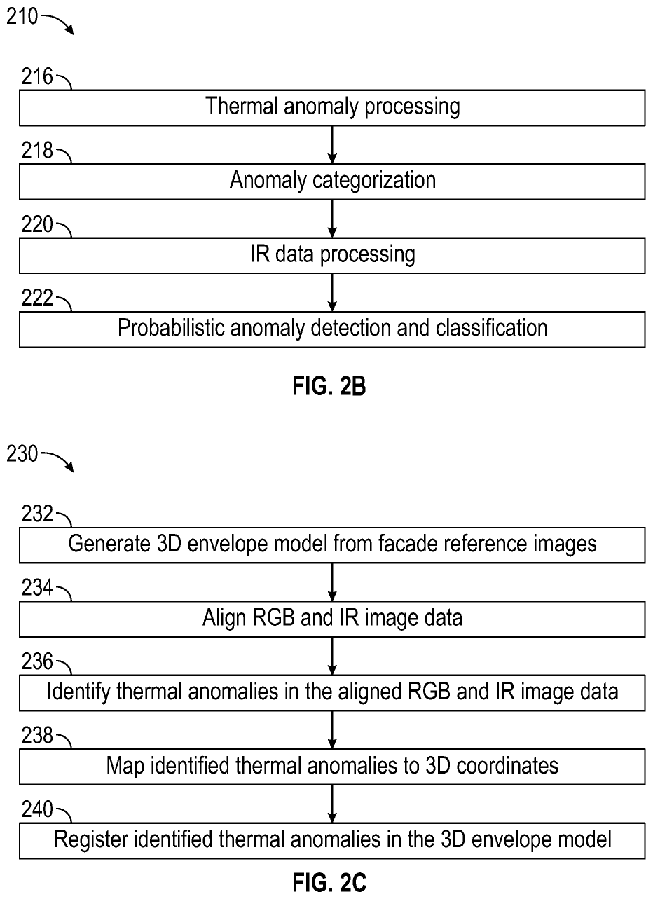

FIG. 2A shows an example method 200 of operation of the unmanned aerial system inspection system (e.g., 100, 100′, and 100″) in accordance with an illustrative embodiment.

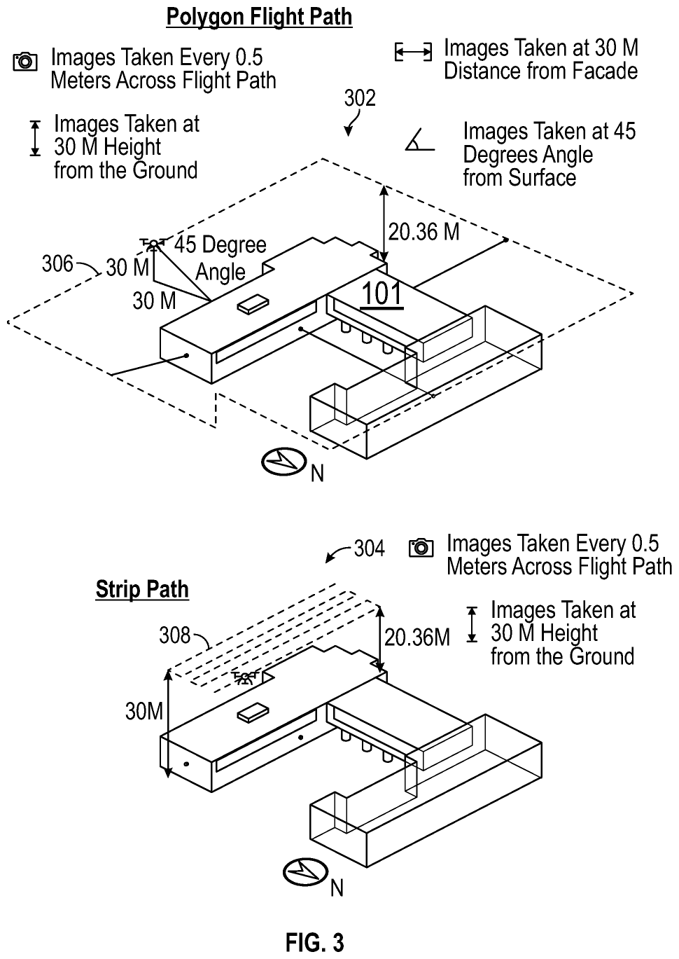

Method 200 includes obtaining (202), by a processor, image data of an unmanned aerial system, wherein the image data are acquired from one or more first visual sensors of the unmanned aerial system. The image data from one or more first visual sensors may be obtained via a first flight path of the unmanned aerial system, the unmanned aerial system comprising one or more second sensors for multi-spectral imaging to maintain a distance to the building envelope according to the first flight path. The image data from one or more first visual sensors are additionally obtained via a second flight path of the unmanned aerial system that maintains a constant elevation in a strip path flight path. In some embodiments, the operation may be performed in relation to FIG. 3.

Method 200 further includes detecting (204) objects, including doors and windows, within the obtained image data. Method 200 further includes identifying (206) the detected objects via one or more classification operations. A first CNN may be employed to classify objects identified with the image. Method 200 further includes determining (208) areas of the detected objects via a second classification operation. Method 200 further includes categorizing (210), via a search model, anomalies in the image data from the first visual sensors. Method 210 may include thermal anomaly processing, anomaly categorization (218), IR data processing, and probabilistic anomaly detection and classification, e.g., as described in relation to FIG. 2B.

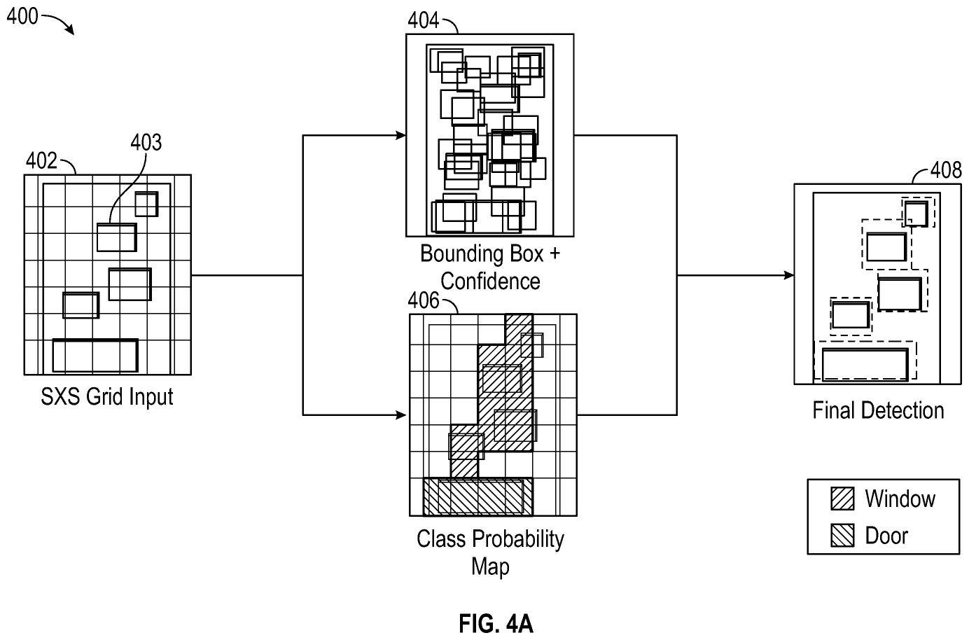

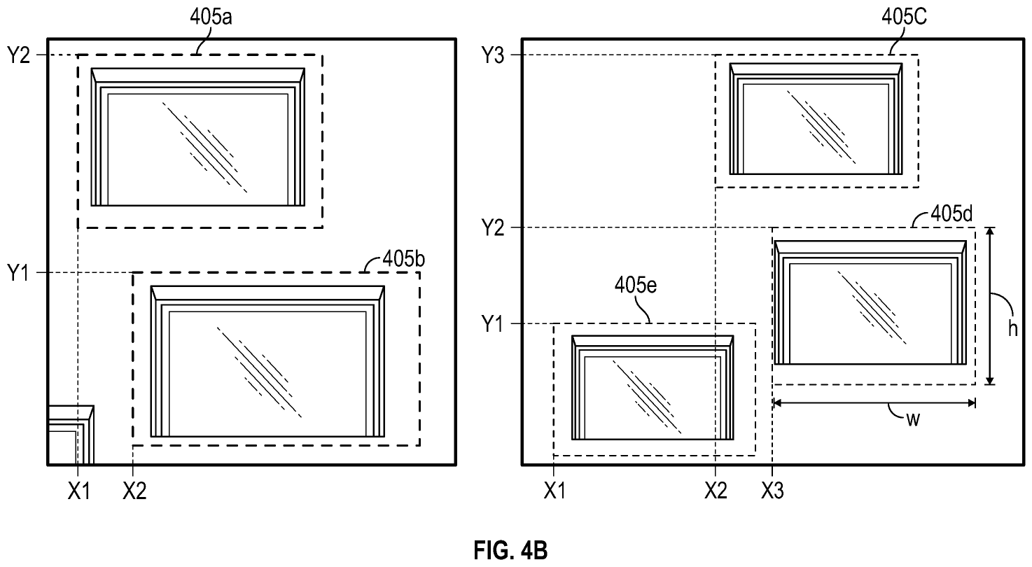

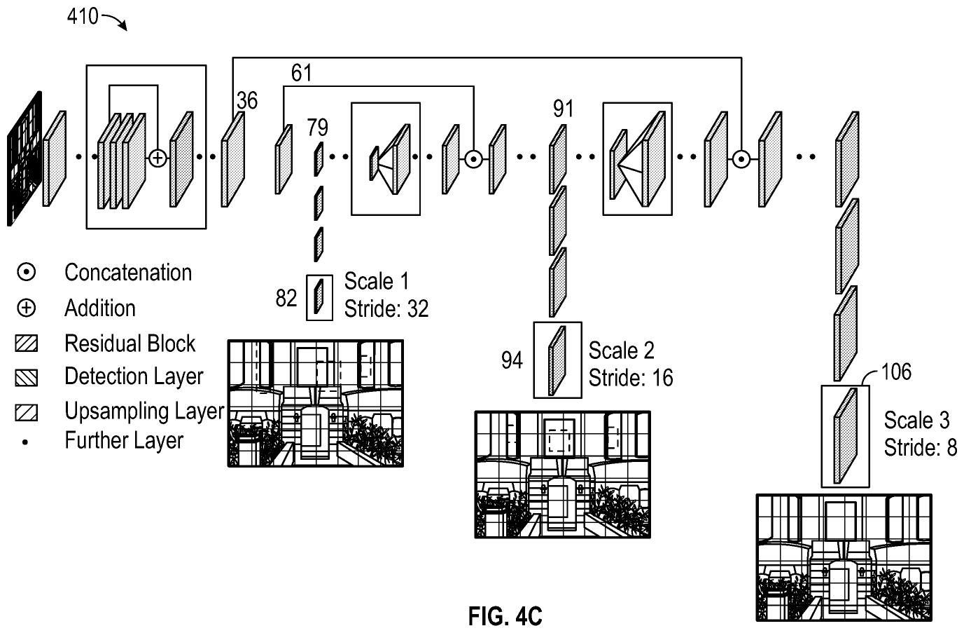

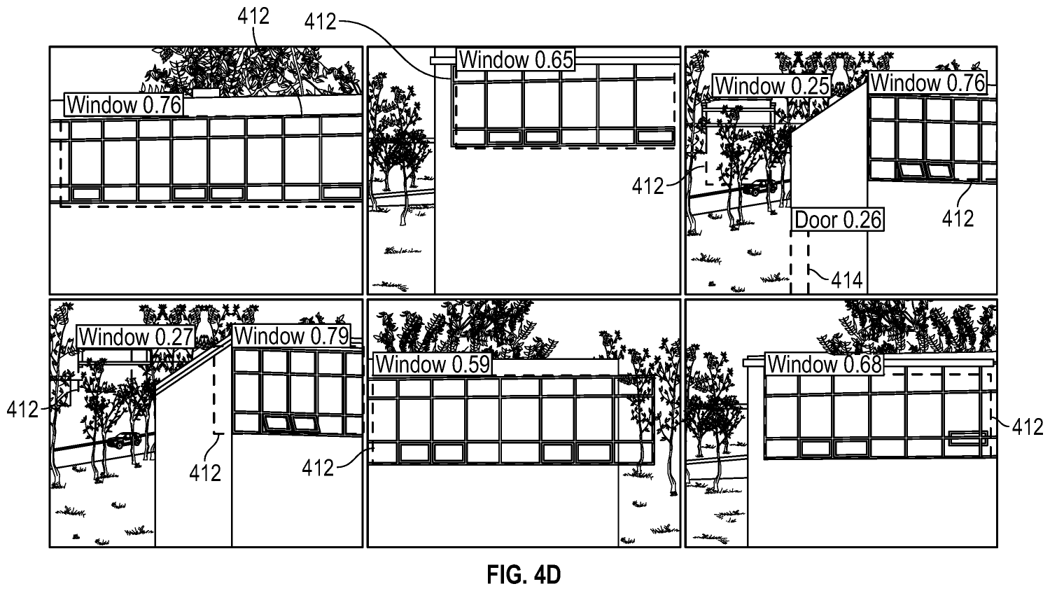

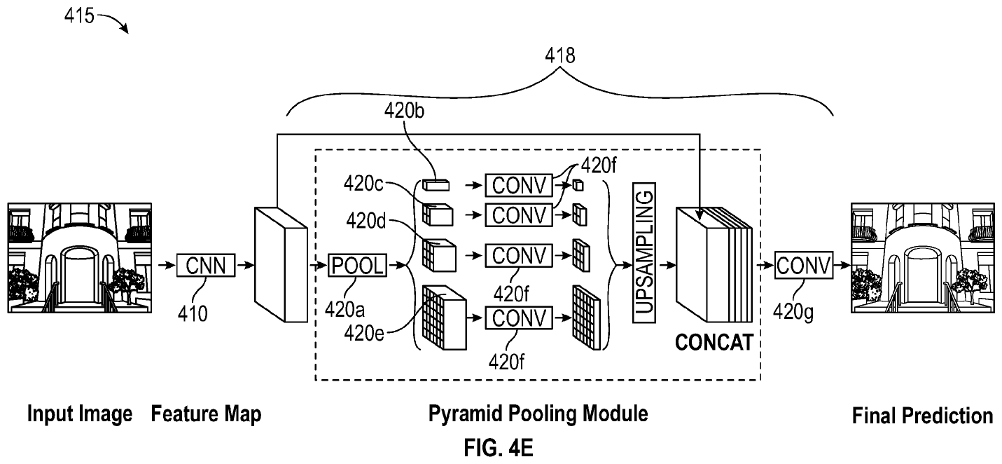

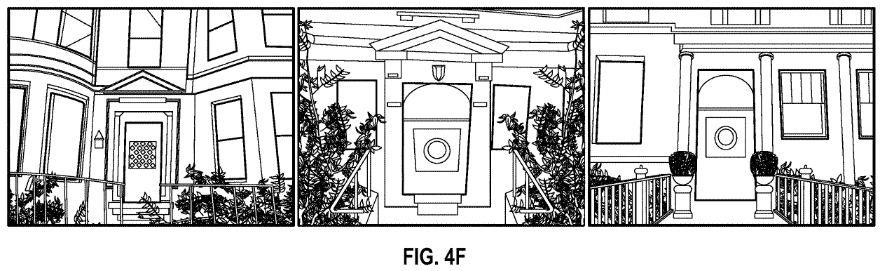

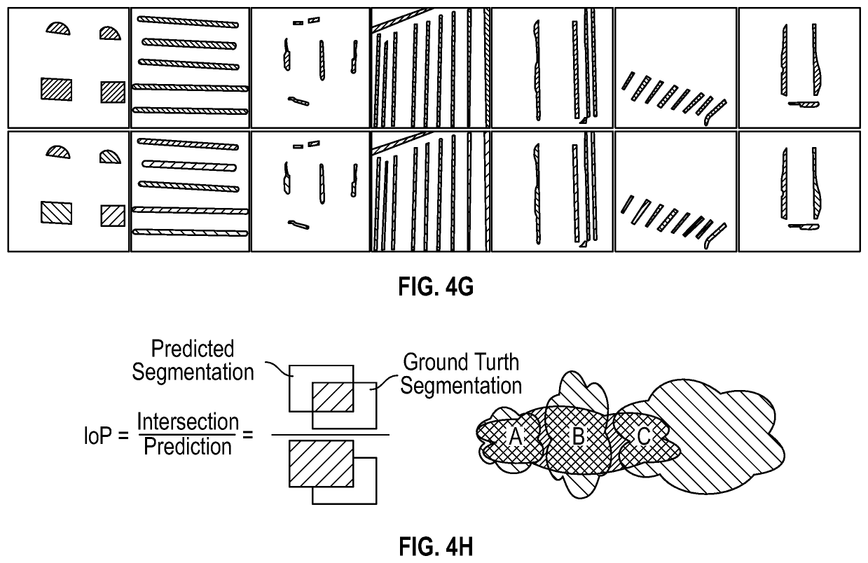

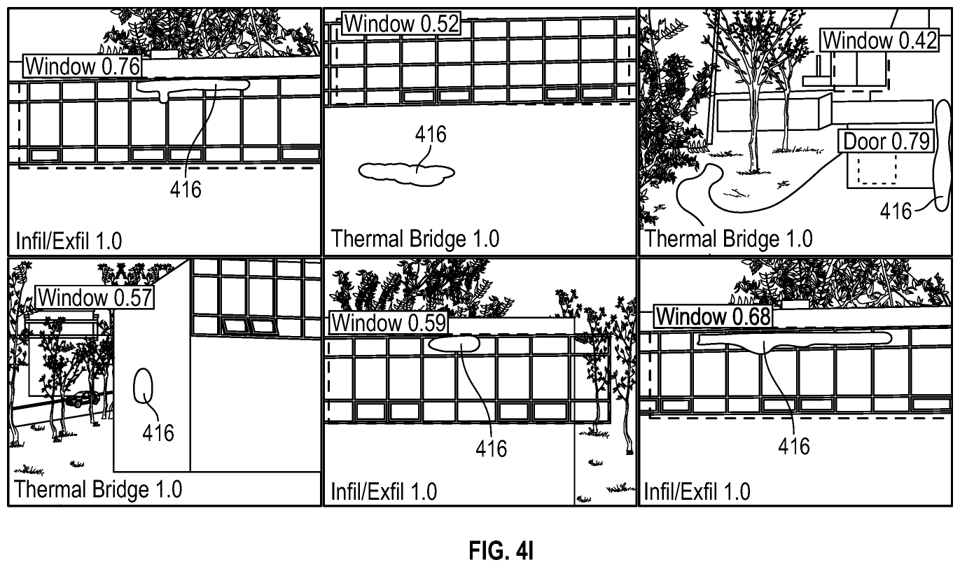

Method 200 further includes combining (212) data of the categorized anomalies with data of the detected objects to quantify each anomaly's probability and class type, wherein the combined data are assigned a thermal characteristic parameter different from that of a three-dimensional model of the building envelope. In some embodiments, the operation of FIGS. 2A and 2B may be performed in relation to FIGS. 4A-4I.

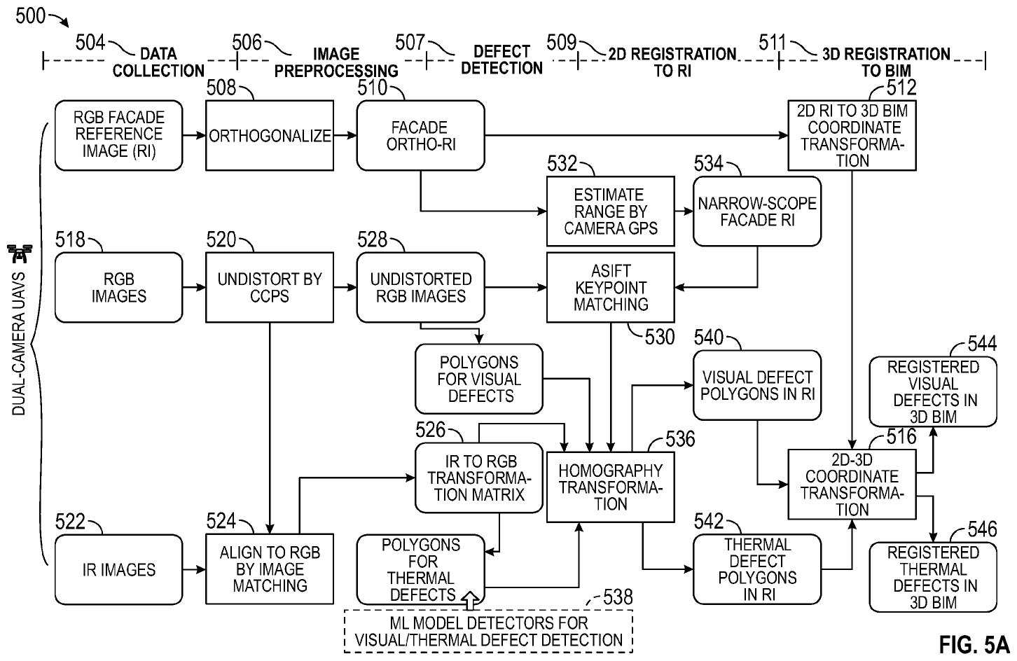

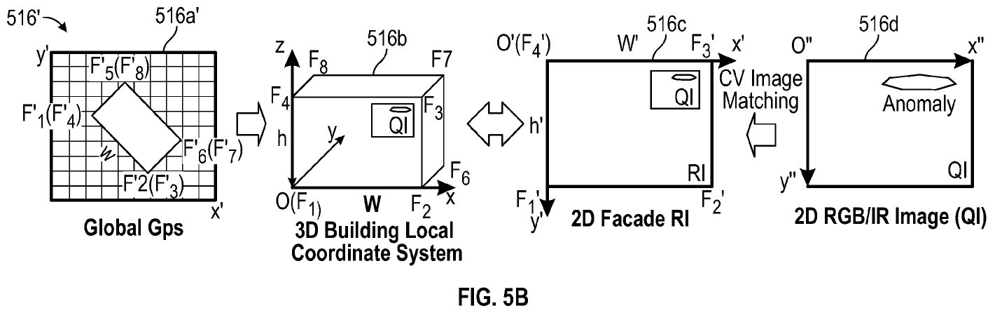

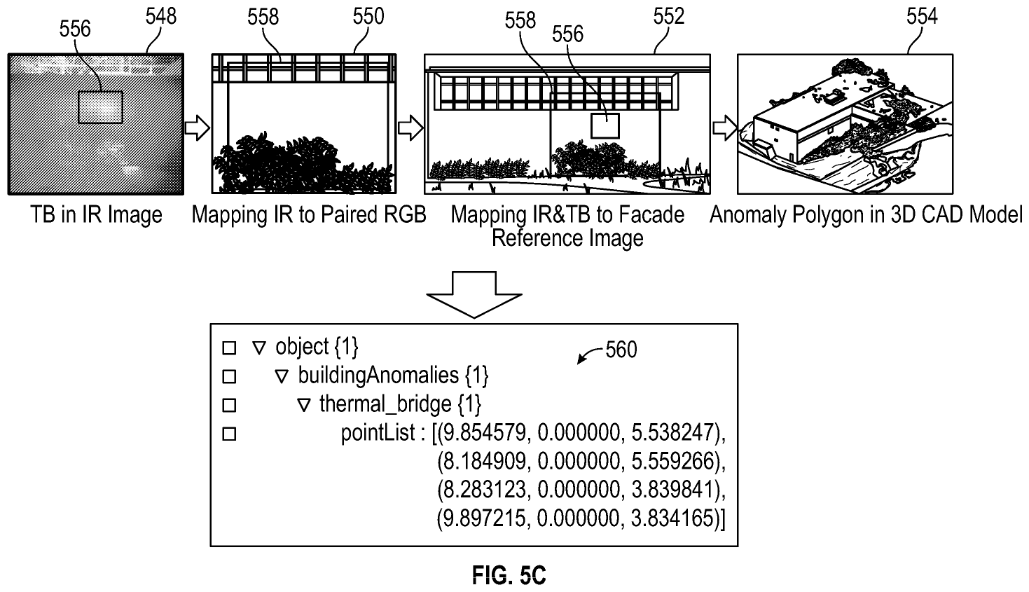

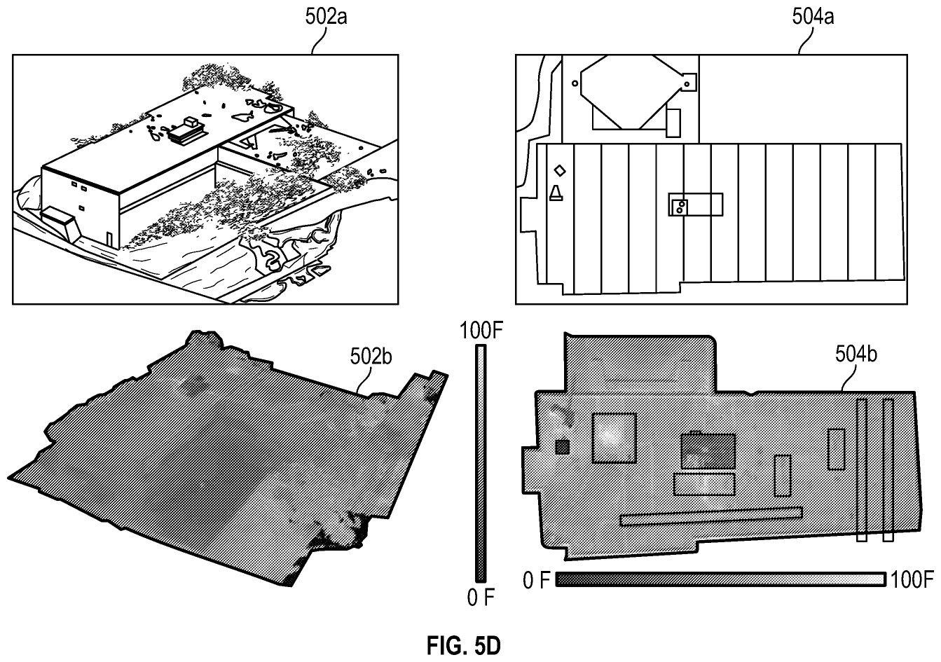

FIG. 2C shows a method 230 to combine the identified thermal detects or anomalies in the building model. Method 230 includes generating (232) 3D envelope models from façade reference images. In some embodiments, a 3D model of the building envelope is generated via a photogrammetry operation. Method 230 further includes aligning (234) RGB and IR image data. In some embodiments, keypoint detection and matching operations are used. Method 230 further includes identifying thermal anomalies in the aligned RGB and IR image data. An AI or ML model classifier may be employed for the RGB or IR images. Method 230 further includes mapping (238) the identified thermal anomalies to 3D coordinates. In some embodiments, the aligned image data of the one or more first visual sensors are mapped, via a homographic transformation operation, to the three-dimensional model of the building envelope. Method 230 further includes registering the identified thermal anomalies in the 3D envelope model. In some embodiments, the operation may be performed in relation to FIGS. 5A-5D.

### Example Operation for Flight Trajectory for Data Collection

The UAS 102, in some embodiments, is configured to take off from a home point to autonomously and systematically collect data for a building's exterior using a payload of nondestructive testing sensors for imaging (visible, infrared, or more) and one or more multi-spectral sensors (LiDAR, ultrasound, radar, or more).

FIG. 3 shows example flight path trajectories (polygon flight path 302, and strip path 304) for the UAS 102 to acquire the sensor data for the inspection analysis in accordance with an illustrative embodiment. In the example shown in FIG. 3, the polygon flight path 302 entails the UAS traveling around the building envelope 101 in a polygonal pattern 306 that is at least 30 meters away from the envelope and at an elevation of 30 meters to provide a 45-degree angle of view. The system may acquire images, including the façade reference images, at every 0.5-meter increments along with the path. The polygon flight path 302 can be initially defined and then modified to provide additional clearance for any impeding structure, e.g., the flight path can be adjusted to provide an offset, e.g., 10 meters, for the nearby tree line.

The strip path flight path 304 entails the UAS traveling around the building envelope 101 in a zig-zag pattern 308 that is over the building structure at a pre-defined fixed elevation, e.g., 30 meters. The system may acquire the images at every 0.5-meter increment along the path. In operating at the fixed elevation, the UAS can capture in the close-up strip paths data, e.g., at a distance of 2-10 meters, from façade surfaces to provide the detailed detection of façade defects or anomalies. The elevation may be adjusted based on information acquired in the polygon flight path 302, which can be used to assess the overall height of the structure.

In some embodiments, the combination of polygon flight path and strip path flight path may be performed in one continuous set of operations. In other embodiments, the polygon flight path may be first employed and completed, and then a second flight for the strip path flight path can be initiated.

Safety consideration. Safety is a key consideration when deploying the UAS for building envelope auditing purposes. During operation, the priority is given to ensuring the perimeter of the flight is clear from all pedestrians. In addition to the above flight paths, the operator can set up a perimeter using cones and tape as well as having designated personnel with two-way radios that would direct incoming traffic and pedestrians away during the flight deployment. In terms of climatic considerations, the operator can deploy the drone only in favorable weather conditions that do not pose mechanical stresses on the drone, such as high wind speeds and excessive heat.

For orbit flights, the operator can deploy the drone at a height that exceeds the height of the tree line by at least around 10 meters. Tree height varies seasonally, so in terms of automated flights, the operator can manually check the tree heights to ensure that the proposed buffer zone is still valid. Strip path audits may pose higher risks as the UAS would be positioned perpendicular to sections of the wall being audited. The UAS should not be deployed under a height of 5 meters. These parameters can be incorporate into the instructions for the flight path of the UAS 102 as constraints or low setpoints.

It is noted that while certain flight planning software may allow the drone to fly at variable auto-generated heights to maintain a fixed height from the terrain over non-uniform topography, this approach poses some risk as topography can be changed over time on the site. There are also risks in the inaccurate operations of the UAS in maintaining the height over a supplied Mean Sea Level (MSL) from the automation software.

To further improve safety operation, the UAS 102 may be configured with real-time kinematic (RTK) modules and ground control stations. RTK-equipped drones have higher position accuracy and can employ RTK output to correct the camera positions with up to two to three centimeters of accuracy. A fixed height may also be preferred to ensure that the flight path is at a safe height without deviation. With this consideration, the façade may be first manually surveyed by the operator to establish a safe zone around it in terms of heights and coordinates, which could then make the task of automating flights safer. For certain drone models without RTK capability, GPS locks may not be as accurate as those equipped with RTK modules. During operation, the operator should ensure multiple GPS locks of high signal strength and establish an error area of approximately 3 m to both ends of the flight path to correct for any GPS-caused deviations.

Climatic conditions should be favorable for effective thermography, whether it is the hot or cold season. For operation during the hot season, deployment of the UAS should be avoided on a sun-exposed surface as it could lessen the surface temperature differential between indoor and outdoor temperatures. The preferred conditions would be early in the morning to inspect the facade of the structure, especially solar-exposed ones.

For operation during the cold season, solar loading could provide a thermal excitation factor to the surface, which could augment the identification of thermal bridges. While direct solar exposure may prove useful for anomaly identification, shading cast on a surface can obscure measurements since shading to a thermal camera could appear no different than a cold spot on a wall. Shading can be avoided, or the system can mask identified shaded areas in the acquired images from the analysis with respect to the identification of anomalies to avert false positives.

Additional descriptions or other examples of operations for the polygon flight path may be found at Brady, James M., et al. “Characterization of a quadrotor unmanned aircraft system for aerosol-particle-concentration measurements.” Environmental science & technology 50.3 (2016): 1376-1383; Aicardi, Irene, et al. “Integration between TLS and UAV photogrammetry techniques for forestry applications.” Iforest-Biogeosciences and Forestry 10.1 (2016): 41; Djimantoro, Michael I., and Gatot Suhardjanto. “The advantage of using low-altitude UAV for sustainable urban development control.” IOP Conference Series: Earth and Environmental Science. Vol. 109. No. 1. IOP Publishing, 2017, each of which is incorporated by reference herein in its entirety. Additional descriptions of operations for the strip path flight path may be found in Murtiyoso et al. 2018, Murtiyoso and Grussenmeyer 2017, each of which is incorporated by reference herein in its entirety.

Discussion By combining images acquired from multiple flight paths, the exemplary system and methods can detect façade anomalies with sufficient accuracy while using less resources and time.

Post-processing of drone-collected data to reconstruct a 3D building model was integral for prior comprehensive façade inspection (Meschini et al. 2014; Unger et al. 2016). Diverse photogrammetry tools have been developed to effectively reconstruct point clouds and 3D models from drone data, including 1) open software such as PMVS, MicMac, Meshroom, VisualSfM, SFMToolkit, bundle adjustment, and python photogrammetry toolbox; 2) commercial software like Agisoft PhotoScan, Acute3D, Photosynth, Arc3D, Autodesk 123D Catch, Pix4D, and PhotoModeler; and 3) CV algorithms like Scale Invariant Feature Transform (SIFT), Speeded-Up Robust Features (SURF), and Structure from Motion (SfM). (Bemis et al. 2014; Eltner et al. 2016; Nex and Remondino 2014; Yahyanejad and Rinner 2015).

Reconstruction of a 3D building model directly from the close-range façade images may be collected in a strip path. High image overlaps may be employed to ensure an easy transition into photogrammetry (Murtiyoso et al. 2018; Murtiyoso and Grussenmeyer 2017). The processing of these highly overlapping images (70-80%) (Rakha et al. 2018) may cost a substantial amount of time (2-14 days) and computing resources to reconstruct a 3D point cloud model with an average resolution of 14-31 mm (Murtiyoso et al. 2018). Indeed, the time-consuming processing and diluted image resolution in reconstructed 3D point clouds may not be effective for the detection of façade anomalies.

Prior research suggests that polygon flight paths (Bertram et al. 2014) and orbit flight paths (Aicardi et al. 2016; Djimantoro and Suhardjanto 2018) have more efficiency in capturing building images and reconstructing 3D building models. Compared with strip paths, orbital flight path patterns are faster in capturing sequential images with enough overlaps to successfully reconstruct a 3D building model. However, such large-scale building images from polygon or circle paths provided insufficient resolution in identifying small anomalies such as cracks.

### Example Structural Envelope Analysis

Referring to FIGS. 1A-1C, the structural envelope analysis module 116 (shown as 116′) is configured to evaluate objects in the building envelope from the acquired sensor data. In the example shown in Module 118′, the module includes a photogrammetry analysis module 140, a geometry translation module 142, and a thermal defect registration module 144.

### Object Detection (Window and Door Identification).

FIGS. 4A-4F show example operations for structural envelope analysis, including object detection in the building envelope in accordance with an illustrative embodiment. Windows and doors are objects in the building envelope that may exhibit different thermal characteristics and performance as compared to other aspects of the building structure, e.g., walls. The system can analyze the acquired data for windows and doors to map those applicable regions in the building model with the appropriate thermal properties.

AI-based Object Classifier. FIG. 4A is a diagram illustrating an example method 400, e.g., for module 116′, to perform object detection in the building envelope, e.g., based on acquired RBG images. Module 116′ employs an AI-based classifier and feature map to identify windows, doors, and other objects on the building structure. The algorithms have been shown to achieve real-time detection with high accuracy and are suitable for detecting semantic objects with repeating structures, such as windows and doors in building facades.

Module 116′, in some embodiments, implements the AI-based classifier and feature map computation in an end-to-end pipeline. The approach may be based on [10-11] and may be further improved using features from [8] and [9]. In the example shown in FIG. 4A, module 116′ first divide (402), for each of the input images or a subset of them, the current input image into an S×S grid, and each cell (403) of the grid are used to predict the object centered in that cell. Module 116′ may examine in the prediction process the center of the semantic component in each cell. The module 116′ produces (404), for the grid, B bounding boxes with a confidence score of χ. The confidence score χ of each predicted class may be calculated using Equation 1.

$$χ = {P}_{class i} \times {Q}_{class i} \qquad ( Eq . 1 )$$

In Equation 1, P is the probability of a detected object in a bounding box B with an accuracy score Q that can account for the fitness between the predicted box and target object. There is an N number of bounding boxes for every image, and each bounding box may be defined by 4 parameters: weight w, height h, and one reference coordinates x,y (e.g., at an upper left corner of each bounding box). FIG. 4B shows two example sets of bounding boxes 405 (shown as 405a, 405b, 405c, 405d, and 405d).

The module (e.g., 116′) may generate (406) a class probability map using the AI classifier. In some embodiments, module 116′ may employ a convolutional neural network (CNN). FIG. 4C shows an example CNN (410) that includes 24 convolution layers and 2 fully connected layers [11]. In the example shown in FIG. 4C, the convolutional layers construct inception modules with a 1×1 reduction layer followed by a 3×3 convolutional layer. The CNN 410 includes a residual network as the model backbone, which has been observed to improve the detection accuracy significantly [8]. It has been observed that the CNN (e.g., 410) can process images in real-time at 78 frames per second (FPS) with few false positives in the background.

Training. In an example, the CNN (e.g., 410) of module 116′ was trained in a study using 3000 images collected from building structures in Boston, MA, and Atlanta, GA, as training data sets with variations of doors and windows for residential buildings type. During the training process, the training system was configured to optimize the loss function using Equation 2.

$${λ}_{c oord} {\sum }_{i = 0}^{{S}^{2}} {\sum }_{j = 0}^{B} {d}_{ij}^{obj} [ {( {x}_{i} - )}^{2} + {( {y}_{i} - )}^{2} ] + {λ}_{c oord} {\sum }_{i = 0}^{{S}^{2}} {\sum }_{j = 0}^{B} {d}_{ij}^{obj} [ {( \sqrt{{w}_{i}} - \sqrt{} )}^{2} + {( \sqrt{{h}_{i}} - \sqrt{} )}^{2} ] + {λ}_{coord} {\sum }_{i = 0}^{{S}^{2}} {\sum }_{j = 0}^{B} {d}_{ij}^{noobj} [ {( {c}_{i} - )}^{2} + {\sum }_{i = 0}^{{s}^{2}} {d}_{i}^{obj} {\sum }_{c ϵ classes} {( {p}_{i} ( c ) - )}^{2} \qquad ( Eq . 2 )$$

In Equation 2, in a given cell i, the center of the bounding box B is denoted as (xᵢ, yᵢ) to the bounds of the grid cell with normalized width wᵢ and height hᵢ relative to the image size. The parameter dᵢ^{obj} represents the existence of an object, ci is the confidence in detection and dᵢⱼ^{obj} specifies that the j^{th} bounding box performed prediction. The loss function (Eq. 2) penalizes classification errors only if an object is located in that grid cell i. Module 116′ assigns a binary variable ϵ[0,1] to represent the state of the selected attributes in each bounding box.

Results. The study implemented the YOLO v5 model[10] as the main structure algorithm for object detection using UAS's RGB and IR data. For the training, the training data were manually labeled with semantic objects for two classes: doors and windows. The CNN (e.g., 410) of the module (e.g., 116) was built based on Keras (Antonio Gulli, 2017) in which 80% of the data were allocated for training and 20% for testing. To assess the effectiveness of detected objects, the training process employed an assessment method [12] in which every classified pixel was classified as either false positive (FP) or true positive (TP), and the precision equals TP/(TP+FP). In the example system, the total mean average precision was 0.862.

To assess the precision of the object detection, the study tested the model with different resolutions and different layout configurations, and the model performed well with low-resolution images captured by the FUR camera.

FIG. 4D shows the results of the detected doors and windows using the testing data set in the study. The overlaid frames 412 represent the detected windows, and the frames 414 denote detected doors, as identified by the algorithm. The mean average precision was 0.862. To assess the precision of the object detection, the study tested the AI model at different resolutions and layout configurations. It was observed that the model performed well with low-resolution images employed in the study as captured by a forward-looking infrared (FLIR) camera.

The study tested the AI model against different resolutions and configurations and utilized the model outputs for window-to-wall (WWR) ratio estimation. The study generated 3D mesh from the UAS RGB data and calculated the fenestration area and applied the calculated WWR for each façade separately. The study combined the façade area segmentation and windows detection to calculate the fenestration area and WWR.

The module (e.g., 116′) may identify, via a final detection operation (408), the doors and windows as semantic objects with varying sizes and poses. The operation may employ multi-scale fusion [9] to detect objects with good adaptability to changes in object sizes. While operation 406 described above may employ the CNN model (410) to detect windows in each façade side as extracted from the 3D mesh, the final detection operation 408 for the area of the detected objects may employ a different AI model.

Semantic Area-Segmentation Classifier. FIG. 4E shows a diagram 415 of the semantic area-segmentation AI model 418 employed for the final detection operation (408) of the area of the identified objects. In the example shown in FIG. 4E, the AI model 418 is implemented as a Pyramid Scene Parsing Network (PSPNet) [13] that is implemented following the CNN 410 to estimate the façade area of the identified objects from the CNN 410. PSPNet is a scene-parsing algorithm based on a semantic segmentation framework for pixel-level detection. The architecture of the algorithm may use a pre-trained ResNet model [8] to extract the feature map that is ⅛^{th} the input image's size. Then the feature map may be overlayed by a pyramid pooling module on top to pool (420a) the feature map to 4 different levels, in which each level is configured with a bin size of 1×1 (420b), 2×2 (420c), 3×3 (420d), and 6×6 (420e) to reduce dimensionality. Subsequently, the pooled feature maps are convolved via a 1×1 convolution layer (420f) where the output of the convolution layer is concatenated to the original feature map. Finally, these outputs are processed by a convolutional layer (420g) to produce the pixel-level detection.

Training. The PSPNet model may be trained using a standard entropy loss function per Equation 3.

$${ζ}_{c e} = \frac{1}{N} {\sum }_{i}^{N} [ {y}_{i} log {p}_{i} + ( 1 - {y}_{i} ) log ( 1 - {p}_{i} ) ] \qquad ( Eq . 3 )$$

In Equation 3, parameter i is the pixel index, N is the number of pixels, y is the ground truth of the façade category, and p is the probability of the predicted object.

Module 116 can calculate the window-to-wall ratio (WWR) based on a number of pixels per detected object (windows) to the total number of pixels of the façade area detected from the PSPNet model. The study performed an image calibration operation using the width and height ratio of the actual façade from the UAS processed data as the reference object to calibrate each representative façade image. The study used the pixel-per-metric (PPM) value to estimate the ratio between the image and the actual façade dimension per Equation 4.

$$ppm = \frac{{B}_{w}}{{f}_{w}} ( in pixels ) \qquad ( Eq . 4 )$$

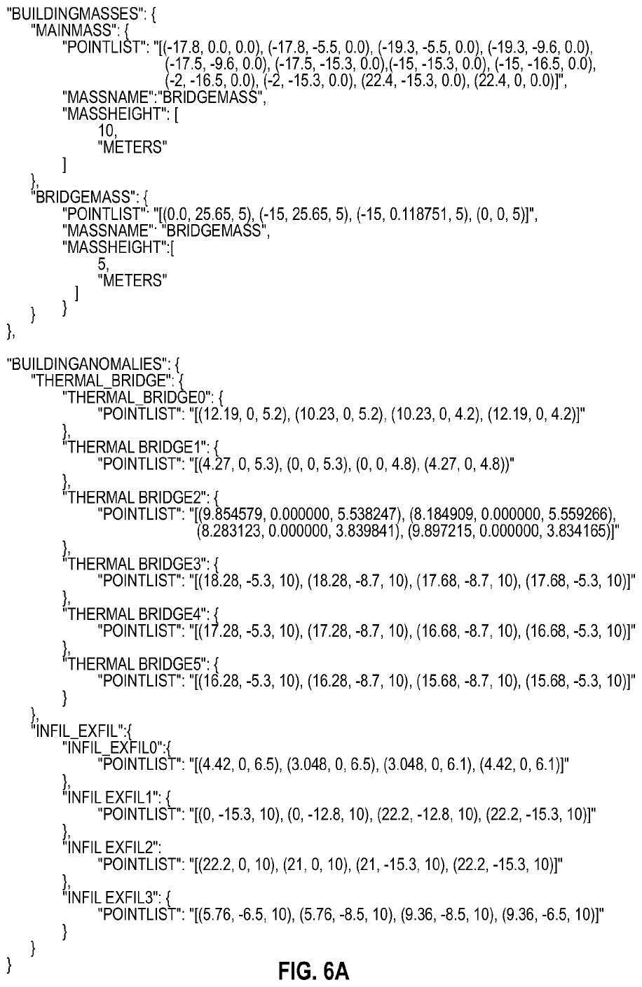

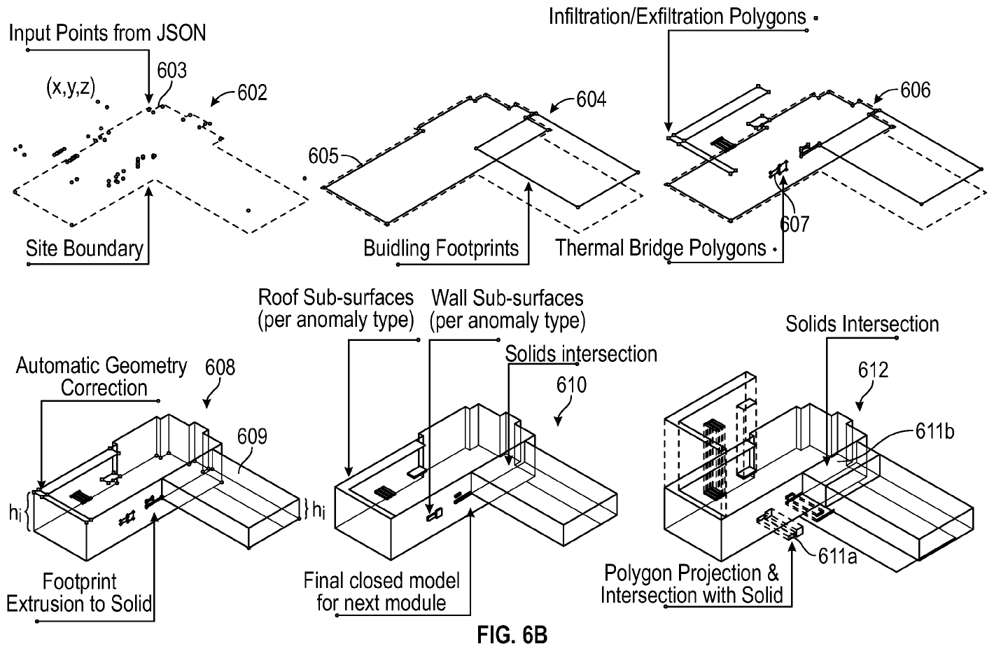

In Equation 4, parameter B_{w} is the width of the image, and ƒ_{w} is the actual façade width measured from the 3D mesh. By using that ratio, the study estimated the size of all the detected bounding boxes in each façade image. FIG. 6 shows an example Façade segmentation output from the PSPNet model. The total fenestration area per each façade is calculated using Equation 5.

$$WWR = \frac{{\sum }_{i = 1}^{n} {B}_{w} \times {B}_{h}}{{f}_{w} \times {f}_{h}} \qquad ( Eq . 5 )$$

In Equation 5, parameter B is the detected window with dimension (w, h), n is the number of detected windows in each façade image, and F is the captured facade image with dimensions (w, h). Similar process may be performed to detect objects, including balconies, shading devices, roofs, roof top units, and others.

Results. FIG. 4F shows façade segmentation output from a PSPNet model employed in a study.

Various research studies have been conducted on the extraction and segmentation of buildings' envelopes using photogrammetry and computer vision techniques. In the field of detecting building envelope objects from images, several models have been developed using deep learning techniques such as Recurrent Neural Networks (RNN) [4] and Convolution Neural Networks (CNN) [5]. These models have been widely used due to their accuracy in detection, that assisted in numerous fields such as object detection [6] and image clustering and classification (Tsung-Han Chan, 2015), which is also incorporated by reference. These approaches via the references are incorporated herein and may be employed in alternative embodiments, among others.

AIM Metric for Segmentation Performance Evaluation. To reduce likelihood or contribution of imprecise prediction instances from contributing to the target identification analysis, the study derived an Anomaly Identification Metric (AIM) for the segmentation operation. Table 1 provides the definition of aspects of the Anomaly Identification Metric.

TABLE 1

| Parameters | Description |
|---|---|
| IoP threshold, T_{IOP} | Criteria for an acceptable (precise) prediction score |
| GTC threshold, T_{GTC} | Criteria for an acceptable coverage score for a target instance |
| True Prediction, TP | Number of prediction instances (components) that sufficiently |
| | overlap with a ground truth instance. (IoP > T_{IOP}) |
| False Prediction, FP | Number of prediction instances (components) that do not |
| | sufficiently overlap with a ground truth instance. (IoP < T_{IOP}) |
| Recalled Target, RT | Number of ground truth instances that are sufficiently covered by |
| | prediction instances. (GTC > T_{GTC}) |
| Missed Target, MT | Number of ground truth instances that are not sufficiently covered |
| | by prediction instances. (GTC < T_{GTC}) |

The study defined the precision as

$$\frac{TP}{TP + FP}$$

per the parameters in Table 1. The study defined recall as

$$\frac{RT}{RT + MT} .$$

per the parameters in Table 1. The precision and recall rates may be employed to indicate how precise the predicted regions are and how much of the ground truth is identified. They can also be used in the evaluation and benchmarking of multiple models.

For a single performance score, the study defined the overall Anomaly Identification Metric (AIM) of a given image (or the entire dataset) per Equation 6.

$$AIM = λ * precision + ( 1 - λ ) * recall \qquad ( Eq . 6 )$$

In the experiments conducted in the study, A is set to 0.25, which gave three times more weight to the “recall” evaluation as compared to the “precision” evaluation. This weight puts more emphasis on the detection of all anomalies as compared to having false predictions. The value of A may be empirically calculated and can be tuned depending on the needs of the application.

AIM is an improvement over prior evaluation metrics. Both qualitatively and quantitatively, the traditional mIoU-based metric (mean intersection over union) can be inaccurate indicator of performance, e.g., when thermal anomaly segmentation is evaluated by building experts and thermography experts. The study observed that expert analysts could give more consideration to whether all anomaly instances are identified rather than the identification of the overlap ratio. Therefore, even if a predicted region does not tightly cover the actual anomaly region, it is, in general, could be sufficient for the identification of that anomaly in thermal inspections.

The study initially employed average precision (AP) as the evaluation metric for the instance segmentation. Traditional AP measures in the thermal anomaly segmentation problem can result in i) anomaly regions that are not necessarily associated with single prediction regions, ii) prediction regions that are not necessarily associated with single ground-truth (GT) regions, and iii) different subjective annotation for the same anomaly region. It is acceptable to have multiple prediction instances covering a GT instance or vice-versa. This may be attributable to the subjectivity of GT instances and the ambiguity of thermal anomalies. To this end, TP, FP, and FN definitions may not hold, and AP may not be determined.

Separating Instances. Since the semantic segmentation model had not provided instance information and the anomaly instances were of arbitrary shapes in the study, the study first applied a preprocessing step to separate instances by the standard connected component analysis. FIG. 4G shows examples of separating instances via a connected component analysis. In FIG. 4G, images in the top row include annotations or the algorithm output, and they do not appear to distinguish between different instances and denote all regions of the same class with the same color (red or green). Images in the bottom row of FIG. 4G show the output of the connected component analysis, where each instance is denoted by a different color.

Intersection-over-Prediction and Ground Truth Coverage Scores. The study defined Intersection-over-Prediction (IoP) as a new measure to score each prediction instance to ensure proper operation of the entire pipeline. As opposed to the traditional IoU metric, where the total area of the intersection of the prediction and ground truth instance is divided by the area of their union, with IoP, the intersection area is divided by the area of the prediction instance only (see FIG. 4H, left). This metric breaks the association requirement and assigns individual scores to each of the prediction instances.

With the IoP approach, scores are only assigned to the prediction instances. To assign a score to a GT (target) instance, the study considered all the prediction instances, which overlap with it, and their IoP score. The score for each GT target is defined as Ground Truth Coverage (GTC) and calculated per Equation 7.

$$G TC = {IoP}_{P 1} * {IoT}_{P 1} + {IoP}_{P 2} * {IoT}_{P 2} + … + {IoP}_{PN} * {IoT}_{PN} \qquad ( Eq . 7 )$$

In Equation 7, the parameter IoPₚᵢ is the IoP score of i^{h} prediction instance that overlaps with the target instance, and IoTₚᵢ is the Intersection-over-Target Area for i^{th} prediction instance. The IoP approach can provide more precise prediction instances; that is, prediction instances with high IoP values would have more weight while contributing to a GTC. This may effectively prevent an imprecise prediction instance from contributing to the target identification analysis.

### Thermal/Envelope Anomaly Detection

Referring back to any one of FIGS. 1A-1C, the system includes a thermal/envelope anomaly detection module 138 that is configured to characterize envelope properties (components, heat resistivity, or others) and identify thermal anomalies (thermal bridges, physical defects, or infiltration/exfiltration), e.g., in a processing pipeline.

FIG. 2B shows a method to identify and categorize anomalies in the image data from the first visual sensors in accordance with an illustrative embodiment. Method 210 includes i) thermal anomaly processing (216), ii) anomaly categorization (218), iii) IR data processing (220), and iv) probabilistic anomaly detection and classification (222), which are shown in relation to FIGS. 4G-4I. FIGS. 4G-4I also show example operations for thermal anomaly detection analysis in the building envelope in accordance with an illustrative embodiment.

Thermal anomaly processing operation (216) may employ image processing operations to enhance the visual integrity and reduce noise and any unwanted signals that may affect the final classification. One example of image processing operations includes a low pass filter, also referred to as a smoothing filter, to remove unwanted signals and spatial noise frequencies in the detected anomaly image data. The low pass filtering operation may be implemented in a moving window operator that can affect each pixel of the image by changing its value (Lee, 1980; Shaikh, 2013) and eliminating any unwanted noise. Operation 216 may employ a low pass filter comprising 5×5 pixels in which h is the spatial frequency, and the transfer function was carried out per Equation 8.

$$y [ i , j ] = {\sum }_{m = - ∞}^{∞} {\sum }_{n = - ∞}^{∞} h [ m , n ] \cdot x [ i - m , j - n ] \qquad ( Eq . 8 )$$

In Equation 8, the parameter y[i, j] represents the new value of each pixel after applying the filter at row i, and column j in the image, and h[m, n] is the low pass filter with dimensions m and n. The filter can smooth out the image at the pixel level to merge the pixels of each anomaly detected.

For anomaly categorization (218), Module 138 may employ the Breadth-First Search (BFS) algorithm [14] to categorize and separate the different anomalies detected in each data point to address instances in which an image can contain more than one anomaly. Module 138 may group pixels of the same color that are connected by a continuous path of neighboring pixels of the same group. Since pixels are processed and stored in a queue connected from the low pass convolutional filter, module 138 may return a set of adjacent pixels of the same color, making this well suited to categorizing different anomalies detected in the same image.

For operation 220, Module 138 may employ the propagation operation for breadth-first traversal as discussed in (Thomas H. Cormen, 1991) in which the system explores pixels and stores them using the function ƒ (ƒ( . . . . . . ƒ(x))), where, x represents the set of pixels of the same color, and this function is repeated recursively until it covers all pixels in the same image.

For probabilistic anomaly detection and classification (222), Module 138 may execute the BFS algorithm on every photo to split each image into multiple versions of the same input containing only one anomaly class. Next, Module 138 may combine the object detection output from the final detection operation 408 with the categorized anomalies from the FBS model to estimate the probability of each anomaly detected. The probabilistic anomaly detection approach may extend conventional object detection and categorized anomalies to quantify each anomaly's probability and class type. The process may employ i) a presence of an anomaly and ii) a detector, to provide the classification for each anomaly detected, which is here a bounding box. Module 138 may calculate the probability distribution P for all anomaly pixels contained in an image using Equation set 9.

$${P}_{\frac{infil}{exfil}} = \frac{{\sum }_{i j} {M}_{anomaly i} \cdot {M}_{box i}}{{\sum }_{i} {M}_{anomaly j}} \qquad ( Eq . Set 9 )$$

$${P}_{Thermal Bridge} = 1 - {P}_{\frac{infil}{exfil}}$$

Module 138 can evaluate the degree of anomaly pixels overlap with the bounding boxes vector for both doors and windows to detect the class of the detected anomaly. In the case of infiltration/exfiltration anomalies, the probability value may be assigned by Module 138 based on the spatial distribution of the anomaly area and a detector. For example, if 100% of the anomaly area is located near a bounding box, Module 138 can assign the probability of the anomaly to be an infiltration/exfiltration class with a value of “1.0” per Equation Set #9. It was observed that the study had an accuracy of the algorithm of 98% based on the trained dataset of 3000 images.

Result. FIG. 4I shows an example final output of module 138 as conducted in the study. The output includes an IR image overlaid with the anomaly class and the associated probability value (shown as 416).

### Example Building Envelope Model Generation and Object Registration

### Photogrammetry and Registration

Referring to FIGS. 1A-1C, the 3D Model generation and registration analysis module 118 (shown as 118′) is configured to generate a building envelope model from the acquired sensor data. In the example shown in Module 118′, the module includes a photogrammetry analysis module 140, a geometry translation module 142, and a thermal defect registration module 144. FIGS. 5A-5D show aspects for building envelope model generation and object registration, e.g., defined in FIG. 2C, in accordance with an illustrative embodiment.

In the example shown in FIG. 5A, the figure shows an example process 500 to generate a synthesized 3D building envelope model or employ one in other embodiments and map the thermal anomalies identified from 2D infrared images, e.g., from module 144, to the synthesized 3D building model. The operation may be performed as a pipeline operation to register visual/thermal defects in UAS images for IR and RGB-acquired images.

Data Collection (504). In this example, a set of drone-captured image sets for a building envelope may be acquired 504 and analyzed, e.g., using the Pix4D software. FIG. 5D shows photogrammetry processing using a photogrammetry application, Pix4D, to reconstruct the 3D visual and thermal model from the RGB images (502a, 504a) and the IR images (502b, 504b) collected from a polygon flight path and a strip flight path, e.g., as described in relation to FIG. 1A. It can be observed in FIG. 5D that the roof infrared images from the strip paths (504b) captured scenes of the building envelope that were mostly in the same plane. The reconstructed 3D roof may be mosaicked into an orthophoto as an RGB and IR orthomosaic roof map (502b, 504b).

Each infrared image captured in the polygon path (502b) may be a combination of the horizontal roof plane and vertical façade plane. The sequenced image sets with 95% overlaps could be employed to reconstruct the 3D building model with the alignment and integration of roof and façade surfaces.

3D registration operation to the BIM (511). Referring back to FIG. 5A, to generate the thermal model reconstructed from RGB images, Module 118 may first generate a synthesized 3D building envelope model. For the examples shown in FIG. 5D, to generate the synthesized 3D building envelope model in the context of a study, image processing operations (506) were performed on the façade RIs by orthogonalizing (508) and by cropping the façade regions through basic image processing tools. During the development of the module, in the study, the images were orthogonalized and cropped using ImageJ.

Module 118 may extract (510) the façade corners within the 2D ortho-RI and map (512) them to the 3D coordinates in the building model via Equation Set 10.

$$\{ \begin{matrix}{ratio}_{x} = {w}^{′} / w {ratio}_{y} = {h}^{′} / h \\ Given {P}_{local} ( x , y , z ) \to \{ \begin{matrix}{x}^{′} = \sqrt{\begin{matrix}{( x - {x}_{{F}_{′}} )}^{2} + \\ {( y - {y}_{{F}_{′}} )}^{2}\end{matrix}} \cdot {ratio}_{x} \\ y ' = h ' - z \cdot {ratio}_{y}\end{matrix} \\ Given {P}_{pixe l}^{′} ( {x}^{′} , {y}^{′} ) \to \{ \begin{matrix}( x , y ) = \vec{{OF}_{1}} + \frac{\vec{{F}_{1} {F}_{2}}}{w} {x}^{′} / {ratio}_{x} \\ z = ( {h}^{′} - {y}^{′} ) / {ratio}_{y}\end{matrix}\end{matrix} \qquad ( Eq . Set 10 )$$

The coordinate transformation (512) between 2D RI coordinate system and 3D building coordinate system may be exported and reused for the registration (e.g., 544, 546) of anomaly pixels in 2D close-up inspection images. FIG. 5B displays a graphical representation of the 2D or 3D coordination transformation 516 (shown as 516′) between global map, building models, façade RIs, and RGB/IR images (query image, QI). In the example shown in FIG. 5B, global GPS data (516a) are employed to generate (516b) the building coordinates. The building coordinates are transformed (via operation 512) to the 2D RI coordinate system and building coordinate system to which 2D RGB/IR images inspected elements may be overlaid.

Image pre-processing. To address distortion between close-up RGB and IR image pairs that are not aligned as captured by the multi-camera drones, operation 500 may first pre-process the RGB images (518) to undistort (520) them by camera distortion parameters. The undistorted RGB images (522) can then be aligned (524) with IR images by computing their grayscale imagery keypoint matches. These matches may be used to calculate the transformation matrix (526) to register IR image pixels to the corresponding RGB image.

2D Registration to Reference Image (509). The undistorted RGB images (528) may be registered to façade RIs by imagery feature keypoint matching operation (530). To improve the registration performance, operation 500 may use the camera GPS (532) and field of view (FOV) to narrow (534) the scope of façade ortho-RIs. In an example implementation, the range of each QI in a façade RI may be estimated as a rectangular box centered in the converted camera position and sized in the FOV plus hover accuracy range. The global GPS may be converted to local building and RI coordinate systems as shown in Equation Set #11 in which the FOV may be estimated by Eq. 12 (Chen et al. 2021).

$$\{ \begin{matrix}θ = {cos}^{- 1} \frac{\vec{{F}_{1}^{∘} {F}_{2}^{∘}} \cdot \vec{{e}_{{x}^{∘}}}}{w} R = [ \begin{matrix}cos θ & sin θ \\ - sin θ & cos θ\end{matrix} ] \\ Given Global {F}_{1}^{∘} ( {x}_{{F}_{1}}^{∘} , {y}_{{F}_{1}}^{∘} ) , {P}^{∘} ( {x}^{∘} , {y}^{∘} ) \to Local P ( x , y , z ) \to \{ \begin{matrix}( x , y ) = {R}^{- 1} \times ( \vec{{P}^{∘}} - \vec{{F}_{1}^{∘}} ) \\ z = AGL {Height}_{P}\end{matrix}\end{matrix} \qquad ( Eq . Set 11 )$$

$$FOV = \frac{W o rking Distance}{Focal Length} , sensor size \qquad ( Eq . 12 )$$

The narrow-scoped façade RI (534) may then be aligned with the undistorted RGB images through ASIFT keypoint detection and matching (530). Then the homographic transformation matrix (536) from undistorted RGB (528) to façade RI (534) may be estimated by the RANSAC method.

Defect Detection (507). In the next step, operation 500 may detect (538) visual or thermal anomalies using ML models, e.g., as described in relation to FIG. 4I and the Thermal Anomaly Classification via Probability Calculation section, to process the RGB or IR images. The previously estimated homographic transformation matrix (536) may be reused to register (540, 542) the visual defects and thermal anomalies to the façade ortho-RI. Specifically, the thermal anomaly polygons within IR images (542) may be transformed to their corresponding RGB image first through the pre-processed IR-RGB transformation matrix. Then the thermal anomalies (542) may become polygons in the RGB image coordinate system, which may then be registered to RIs following the same procedure. Such visual defect or thermal anomaly polygons in façade RIs may be furtherly registered (544, 546) to the 3D building coordinate system through the 2D to 3D coordinate transformation defined in Eq. Set 10. In the end, the visual defects detected in RGB images and thermal defects detected in IR images may be registered to the 3D building model to support the assessment and documentation work.

FIG. 5C provides an example of one detected thermal anomaly instance as an example to present the registration process using the operation described in FIG. 5A. The segmented anomalies within IR images were sequentially aligned in the presented analysis with the corresponding RGB images (548, 550), matched with the façade ortho-RI (552), and registered to the 3D building model (554). As a result, the bounding box 556 of each anomaly instance 558 may be transformed into the 3D space by computing their vertex coordinates in the local building coordinate system. In the end, the generated coordinates were organized into a JSON file (560) to represent each diagnosed thermal anomaly instance.

Geometry Translation from JSON to CAD. Module 118 may automate the workflow for the generation of a 3D model suitable for energy simulation that originates from a JSON file. The translation may be an intermediate step between the photogrammetry workflow and the energy modelling workflow to provide the geometry input for the energy simulation module presented next in this report.

In some embodiments, the JSON file may be generated in a lightweight, multidimensional data storage and interchange format that contains minimal input information in a text format for the construction of the 3D model. The JSON file may include the key-value pairs for the field names of 1) the Building Mass with branches for each major mass or place where the footprint of the building changes and 2) the Building Anomalies, which may be further divided into a) the Thermal Bridge and b) the Infiltration/Exfiltration sub-categories. Moreover, the values may be in the form of ordered point (e.g., XYZ) coordinates, as well as the heights of the building volumes in metric units. FIG. 6A shows an example JSON file, and FIG. 6B shows the operation of a 3D model from the JSON file.

3D Envelope Building Model. In one example implementation, the workflow may be created in the Rhino/Grasshopper environment, and a ghPython module may be employed that takes the JSON file with the prescribed JSON structure to generate and output the geometric model to be employed for the energy simulation. The generated building or envelope model may include i) building mass geometry (in which each building volume is on a separate sub-layer) ii) common surfaces between two adjacent volumes iii) thermal anomalies classified by anomaly type and by location (e.g., for walls and roof). The thermal anomalies may be defined as sub-surfaces of the building mass to be compliant with the energy simulation geometry requirements.

FIG. 6B shows the operation 600 of a 3D model from a JSON file. In FIG. 6B, from top left to bottom right, the diagram shows the geometry generation operation: from points, to lines, to solid masses and the intersection between the building masses and the anomaly polygons.

The model generation operation 600 may begin with a transformation operation 602 that translates coordinates stored in the JSON to 3D points 603. Operation 600 may create (604) 2D boundaries 605 of the building masses and create (606) thermal anomaly polygons 607. During the operation 600, any intersecting polygons may be unified into a single polygon. Operation 600 may extrude (608) the 2D boundaries 605 of the building masses in the z-axis using a height value stored in the JSON file to form solid geometries 609. Operation 600 may then intersect (610) the 2D anomaly polygons 607 with the solid building geometries 609 to form the sub-surfaces discussed above. The operation may perform a final step to check for intersection 611 (shown as 611a, 611b), or overlapping surfaces between the building volumes so that the common surfaces can be identified appropriately and form Energy Plus-compliant thermal zones.

Operation 600 may be further extended to also include envelope openings, such as windows and doors, which may be described in the same or similar manner as the thermal anomalies.

### Example Building Energy Modeling

Referring to FIGS. 1A-1C, the analysis system 104 employing analysis 122, e.g., comprising a thermal evaluation of the building envelope as a Building Energy Model (BEM), to provide a report 124 of the same. To represent envelope anomalies, the exemplary system and method may identify thermal bridges and infiltration/exfiltration objects. In some embodiments, the exemplary system and method may additionally identify moisture-based anomalies that can affect the thermal performance of the building envelope. Building Energy Modeling (BEM) can provide the user with tools to estimate and quantify a building's performance.

Due to the complex nature of building performance and the multitude of factors that can affect it, a conventional BEM system can employ a number of assumptions on different levels of the energy model to expedite the simulation process. These assumptions can create degrees of inaccuracy and uncertainty. Of those that may be made is the assumption that the building envelope has uniform performance across its surfaces in traditional Conduction Transfer Function (CTF) simulations. When BEM employs the temperature variances between the indoor and outdoor environment as the main component in the calculation of the HVAC loads, the accurate representation of envelope anomalies in BEM can affect the accuracy of the results. Traditionally, BEM anomalies have been identified through inverse modeling operations where lapses between the measured and modeled data would be attributed to different factors, including areas of high thermal conductance, infiltration, or other factors (Burak Gunay et al., 2019).

Anomaly Representation—Thermal Bridges. Module 122 may be configured to utilize infrared thermography readings to identify areas of interest, e.g., for thermal bridges. The operation may average the temperature within an identified polygon (e.g., as described in relation to FIG. 5C) and compare it to a non-anomalous patch of the envelope to establish a percentage difference in temperature between the two areas. The heat gain coefficient for each area is then identified using Equation 13.

$$\frac{ε σ ( {T}_{refl} - {T}_{s , in} ) + {h}_{c} ( {T}_{i n} - {T}_{s , i n} )}{{T}_{s , in} - {T}_{s , out}} \qquad ( Eq . 13 )$$

In Equation 13, the emissivity parameter ε may be set on a spectrum ranging from “0.1” to “1,” the convection coefficient σ may be set to 8.7 W/m²K (as one example), the Stefan-Boltzmann constant may be set to 5.67e⁻⁸ W·m⁻²·K⁻⁴, while h_{c} is the convection coefficient, T_{refl} is the reflected temperature, T_{s,in} is internal surface temperature, Tᵢₙ is the indoor ambient air temperature and T_{s,out} represents the external surface temperatures. The convective coefficient may be based on or adjusted by the standard wind condition as suggested by ASHRAE standards (ASHRAE, 2017). Thermal transmittance of each façade may be calculated separately by averaging temperature readings (e.g., 500 readings) in each façade to calculate the overall U-value of the façade. Areas with different U values may be averaged using Equation 14.

$${UAS}_{g} = {U}_{1} * \frac{{A}_{1}}{{A}_{1} + {A}_{2}} + {U}_{2} * \frac{{A}_{2}}{{A}_{1} + {A}_{2}} \qquad ( Eq . 14 )$$

In Equation 14, UASg is the overall U-value, U₁ is the U-value calculated for areas with thermal differences, U₂ is the U-value calculated for total façade area, and A₁ is the area of the thermal anomaly. After the calculation of the different U-Values for the patches, those are assigned to the separately modeled patches accordingly. Additional descriptions may be found in [25].

Anomaly Representation—Infiltration Exfiltration. Module 122 may be configured to evaluate the infiltration/exfiltration anomalies in the areas of the polygons identified by the computer vision algorithm by inputting them as into a ZoneInfiltration:EffectiveLeakageArea object in EnergyPlus that is based on the Sherman-Grimsrud (1980) model, e.g., described in the ASHRAE Handbook of Fundamentals (2001 Chapter 26; 2005 Chapter 27) where it is referred to as the “Basic” model per Equation 15.

$$infiltration = {F}_{schedule} \frac{{A}_{L}}{1000} \sqrt{{C}_{s} Δ T + {C}_{W} {Windspeed}^{2}} \qquad ( Eq . 15 )$$

In Equation 15, ΔT is the average difference between the zonal air temperature and outdoor air temperature; A_{L} is the effective leakage area in cm², e.g., at 4PA; Cₛ is the stack coefficient in (L/s)²/(cm⁴·K); C_{w} is the wind coefficient, and F_{schedule} is the Infiltration Schedule

Modeling Methodology. After the polygons are identified and translated, e.g., into Rhino 3D using the processes described previously, Module 122 may then create the energy model. In some embodiments, the Ladybug+Honeybee plugins for Grasshopper may be implemented in Rhino. While the current process requires the user to create BEM manually in Honeybee, Module 122 may utilize the registered polygons for anomaly representation to create the energy model.

In one embodiment, Module 122 may model the thermal zones for the target building and then deconstruct them into their corresponding surfaces. The anomalies may then be grafted onto the surfaces in the position where they were identified, and a unique R-Value identified in the process described above may be set for the anomaly to represent the thermal bridge at the exact geometric position. The thermal zone may then be reassembled and added to the BEM model. For infiltration/exfiltration, the areas of the identified polygons may be calculated and may then be inputted into the ZoneInfiltration:EffectiveLeakageArea to factor it in.

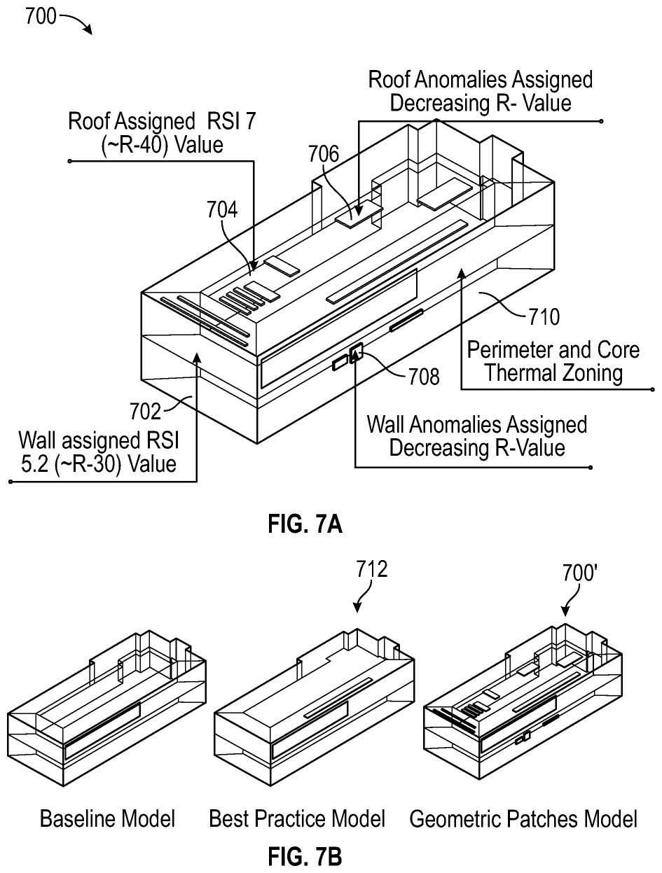

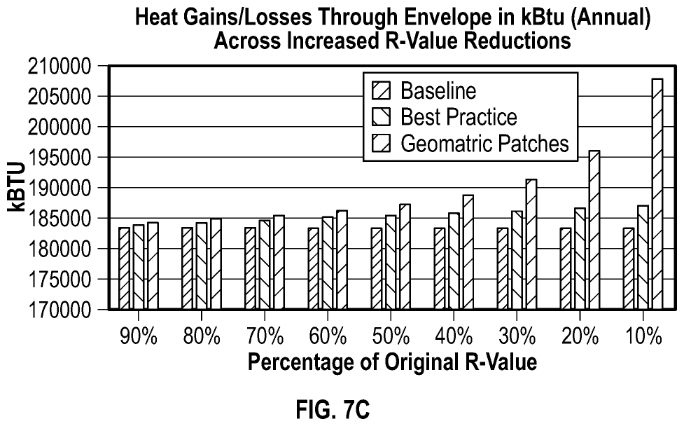

FIG. 7A shows an example building energy model 700 as implemented for the model generated in the example of FIG. 6. The model 700 thermal parameters R being assigned for the walls 702, roof 704, roof anomalies 706, wall anomalies 708, and perimeter and core thermal zones 710.

FIG. 7B shows a comparison of the building energy model 700 (shown as 700′) of FIG. 7A to other models. It can be observed that the best practice model 712 does not require rigorous modeling procedures, which could cause imbalances in the BEM. As both approaches (700′ and 712) utilize EnergyPlus as the simulation engine and not a new or different solver, it satisfies the ASHRAE Standard 140-2017 Class 1 compliance.

Simulation Test Case. Using the Georgia Tech Architecture East building as an example case, the study utilized Ladybug+Honeybee plugins for Rhino 3D as a modeling environment for simulation in EnergyPlus. The areas of interest were modeled as patches on the roof and wall surfaces of the and are assigned a different EnergyPlus no mass materials that can vary from that assigned to the remainder of the surface area (FIG. 7B). FIG. 7B shows an Arch East Model used in simulation with anomaly patches. The purpose of this experiment is to showcase the successful implementation of the methodology described above as well as simulate scenarios showing how increased R-Value degradation affects the envelope gains/losses over an annual period.

To study the effect of the latter, we utilized a 7 RSI (˜R-40) high-performance roof value as the standard roof R-Value. The walls were assigned a 5.2 RSI (R-30) value throughout the simulations. Then the patches were assigned a reduced R-Value in decreasing increments of 10% over a series of 10 simulations.

For the remaining simulation parameters, the weather file utilized was that of Atlanta Hartsfield-Jackson Airport. For HVAC settings, an “Ideal-Air Loads” zone object was assigned to the thermal zones. All other simulation parameters were applied using the ASHRAE 90.1-2010 Open Office Building template for ASHRAE Climate Zone 3A. The thermal zoning was designed using a perimeter and core strategy to avoid utilizing a single thermal zone shoebox model for the building that would make differences in energy consumption indiscernible between simulations due to constant fan usage. The output to be compared is the Surface Average Face Conduction Gains and Losses.

Results. FIG. 7C shows the results of the simulation. The results indicate that for smaller percentage reductions (50-90%), the exemplary AirBEM Geometric Patches (GP) approach and the previously described Best Practice (BP) approach indicated <1% difference in their expected outputs. However, for percentage reductions <50%, the difference increases substantially, with the GP model showing a much larger deviation from the baseline, while the BP approach remains consistent. As the reductions increased, the exemplary BP approach showed little deviation from the baseline, with a change of 1.91% at its maximum, while the GP approach indicated a 12.43% deviation from the baseline, which would be consistent with the presence of such large-scale thermal bridges).

Discussion The differences between both methods could be attributed to solar heat gain at geometric patches being better represented in the GP case than the BP case. Geometric localization, thus, would be of benefit in modeling more severe thermal bridge anomalies. What remains is that an inverse model of the building would identify which of the two approaches was closer to measured and metered data and how well each represented the anomalies.

Table 1 shows percent changes between the Baseline, Best Practice (BP), and Geometric Patches (GP) models.

TABLE 1

| | % Change | % Change | % Change |
|---|---|---|---|
| % R-Value | between GP | between GP | between BP |
| Reduction | and BP | and Baseline | and Baseline |
| 90% | 0.23% | 0.42% | 0.19% |
| 80% | 0.29% | 0.67% | 0.38% |
| 70% | 0.41% | 0.99% | 0.58% |
| 60% | 0.46% | 1.42% | 0.96% |
| 50% | 1.00% | 1.99% | 1.00% |
| 40% | 1.61% | 2.83% | 1.22% |
| 30% | 2.72% | 4.16% | 1.44% |
| 20% | 4.91% | 6.58% | 1.67% |
| 10% | 10.53% | 12.43% | 1.91% |

It is estimated that the current Arch East building is experiencing a 50% reduction in its anomalies, which is simulated through our GP approach to be at 1% from the BP model. This indicates the “Go” criterion has been met. However, it is important to note that if the % reduction in performance is significant, the change between the GP and BP shows that the BP modeling approach is much less reliable, as it continues to be much closer to the baseline. When the anomalies are severe, the GP should be employed, and if they are minimal, the BP approach can be sufficient.

Discussion The advantages and improvements of each of the BERDs framework components have been described within their respective component section above. The general advantage is the streamlined process from flight to envelope characterization, followed by geometry creation and translation into BEM.

Indeed, the exemplary system and method may be employed for the retrofitting of existing buildings, which represent a significantly growing market and an opportunity to achieve some of the most sizable and cost-effective energy reductions in any sector of the economy. Since buildings consume a significant amount of energy (40% of the nation's total U.S. energy consumption), particularly for heating and cooling (32%), and because existing buildings comprise the largest segment of the built environment, the building retrofit industry has a critical scope. More than half of all U.S. residential and commercial buildings in operation today were built before 1980, and this large existing building stock performs with generally lower efficiency. The US Green Building Council estimates that more than $279B could be invested across the residential, commercial, and institutional market segments in building upgrades and retrofits in the U.S., with 2% of existing space renovated each year and that 10% of these renovations include state-of-the-art energy efficiency. Investments in residential energy efficiency upgrades offer $182B of investment potential, much of it in single-family residential properties. Commercial real estate sectors offer $72B of investment potential, distributed across a variety of sub-segments and institutional real estate offers $25B of investment potential.

Companies in the market today provide a group of services such as emergency parts replacement, facility maintenance, and energy monitoring, along with retrofitting and optimization solutions across industries and building structures. A typical retrofit process starts with a building owner or a contractor. After selecting from a portfolio of buildings by benchmarking them against energy consumption standards, a contractor/owner selects a project to work on, secures funding and selects audit protocol. Based on the audit protocol, the contractor/owner selects an auditor and gets the audit done. It generally takes weeks (1-7 days for 100K sq. ft.) to inspect a facility which is done manually by taking digital images, thermal images, and videos of the facility. These images are then used to understand further and create a 3D visualization of building components and energy consumption. Traditional energy modeling capabilities require weeks to months (1-4 months for a 100K sq. ft.) to construct using software before they can provide the information necessary to guide the design and retrofit process, and hence this is often restricted to high-budget project. Post-audit, the final scope of the work is determined and evaluated based on the auditors' recommended measures. The results often do not accurately represent the measured energy use in an operational building. Based on the calculations, the proposed solutions are chosen based on financial viability, savings on utility bills, and payback analysis, utility cost-saving being the major influencing factor in decision-making.

### DISCUSSION

U.S. Ser. No. 10/055,831B2 specifically focuses on micro scans and does not sufficiently describe the use of 1) multiple NDT techniques 2) the use of photogrammetry for defect registration and 3) the translation of geometries into whole BEM.

WO2018089268A1 does not include any autonomous defect detection, CAD translation or energy modeling. It describes a generic scanning approach to infrastructure.

KR101707865B1 focuses on a photography approach and makes no use of such photography beyond the identification of a defect.

US11106208B2 does a generic robot inspection to communicate findings but does not automate the inspection process itself without knowing any of the building parameters. It does not describe digital modeling and simulation.

It should be appreciated that the logical operations described above and, in the appendix, can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

Machine Learning. In addition to the machine learning features described above, the various analysis system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

NeuralNetworks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an ANN is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or another organism, living or dead, or other biological or molecular structure or chemical environment, and may relate to particular components of the subject, for instance, specific tissues or fluids of a subject (e.g., human tissue in a particular area of the body of a living subject), which may be in a particular location of the subject, referred to herein as an “area of interest” or a “region of interest.”

It should be appreciated that, as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to humans (e.g., rat, dog, pig, monkey), etc. It should be appreciated that the subject may be any applicable human patient, for example.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth 10 references in the list. All references cited and discussed in this specification are incorporated herein by reference in their entireties and to the same extent as if each reference was individually incorporated by reference.

### REFERENCES

[1] Brady, James M., et al. “Characterization of a quadrotor unmanned aircraft system for aerosol-particle-concentration measurements.” Environmental science & technology 50.3 (2016): 1376-1383
[2] Aicardi, Irene, et al. “Integration between TLS and UAV photogrammetry techniques for forestry applications.” Iforest-Biogeosciences and Forestry 10.1 (2016): 41
[3] Djimantoro, Michael I., and Gatot Suhardjanto. “The advantage by using low-altitude UAV for sustainable urban development control.” IOP Conference Series: Earth and Environmental Science. Vol. 109. No. 1. IOP Publishing, 2017.
[4] Graves, Alex, and Jürgen Schmidhuber. “Offline handwriting recognition with multidimensional recurrent neural networks.” Advances in neural information processing systems 21 (2008).
[5] Krizhevsky, Alex, Ilya Sutskever, and Geoffrey E. Hinton. “Imagenet classification with deep convolutional neural networks.” In Advances in Neural Information Processing Systems (NIPS), pp. 1097-1105. 2012.
[6] Ren, Shaoqing, et al. “Object detection networks on convolutional feature maps.”0 IEEE transactions on pattern analysis and machine intelligence 39.7 (2016): 1476-1481.
[7] Redmon, Joseph, et al. “You only look once: Unified, real-time object detection.” Proceedings of the IEEE conference on computer vision and pattern recognition. 2016.
[8] He, Kaiming, et al. “Deep residual learning for image recognition.” Proceedings of the IEEE conference on computer vision and pattern recognition. 2016.
[9] Lin, Tsung-Yi, et al. “Feature pyramid networks for object detection.” Proceedings of the IEEE conference on computer vision and pattern recognition. 2017.
[10] Dai G, Hu L, Fan J. DA-ActNN-YOLOV5: Hybrid YOLO v5 Model with Data Augmentation and Activation of Compression Mechanism for Potato Disease Identification. Comput Intell Neurosci. 2022 Sep. 23; 2022:6114061. doi: 10.1155/2022/6114061. PMID: 36193182; PMCID: PMC9525742.
[11] Joseph Redmon, AliFarhadi, “YOLO v3: An Incremental Improvement,” arXiv preprint arXiv:1804.02767 (2018).
[12] Han, Hua, et al. “Ensemble learning with member optimization for fault diagnosis of a building energy system.” Energy and Buildings 226 (2020): 110351.
[13] Zhao, Hengshuang, et al. “Pyramid scene parsing network,” Proceedings of the IEEE conference on computer vision and pattern recognition, 2017.
[14] Silvela, Jaime, and Javier Portillo. “Breadth-first search and its application to image processing problems.” IEEE Transactions on Image Processing 10.8 (2001): 1194-1199.
[15] Meschini, Alessandra, et al. “POINT CLOUD-BASED SURVEY FOR CULTURAL HERITAGE. AN EXPERIENCE OF INTEGRATED USE OF RANGE-BASED AND IMAGE-BASED TECHNOLOGY FOR THE SAN FRANCESCO CONVENT IN MONTERUBBIANO.” International Archives of the Photogrammetry, Remote Sensing & Spatial Information Sciences 45 (2014).
[16] Unger, Daniel, et al. “Integrating faculty led service learning training to quantify height of natural resources from a spatial science perspective.” (2016).
[17] Bemis, Sean P., et al. “Ground-based and UAV-Based photogrammetry: A multi-scale, high-resolution mapping tool for structural geology and paleoseismology.” Journal of Structural Geology 69 (2014): 163-178.
[18] Eltner, Anette, et al. “Image-based surface reconstruction in geomorphometry-merits, limits and developments.” Earth Surface Dynamics 4.2 (2016): 359-389.
[19] Nex, Francesco, and Fabio Remondino. “UAV for 3D mapping applications: a review.” Applied geomatics 6.1 (2014): 1-15.
[20] Yahyanejad, Saeed, and Bernhard Rinner. “A fast and mobile system for registration of low-altitude visual and thermal aerial images using multiple small-scale UAVs.” ISPRS Journal of Photogrammetry and Remote Sensing 104 (2015): 189-202.
[21] Murtiyoso, Arnadi, et al. “Open source and independent methods for bundle adjustment assessment in close-range UAV photogrammetry.” Drones 2.1 (2018): 3.
[22] Murtiyoso, Arnadi, and Pierre Grussenmeyer. “Documentation of heritage buildings using close-range UAV images: dense matching issues, comparison and case studies.” The Photogrammetric Record 32.159 (2017): 206-229.
[23] Rakha, Tarek, and Alice Gorodetsky. “Review of Unmanned Aerial System (UAS) applications in the built environment: Towards automated building inspection procedures using drones.” Automation in Construction 93 (2018): 252-264.
[24] Murtiyoso, Arnadi, et al. “Open source and independent methods for bundle adjustment assessment in close-range UAV photogrammetry.” Drones 2.1 (2018): 3.
[25] Bayomi, Norhan, et al. “Building envelope modeling calibration using aerial thermography.” Energy and Buildings 233 (2021): 110648.
[26] U.S. Ser. No. 10/055,831B2.
[27] WO2018089268A1.
[28] KR101707865B1.
[29] U.S. Ser. No. 11/106,208B2.

1. A system for exterior building envelope inspection comprising:
an unmanned aerial system (UAS);
a payload comprising (i) first visual sensors configured for imaging of the building envelope and (ii) one or more second sensors for multi-spectral imaging; and
a computer vision and signal processing system, the computer vision and signal processing system being configured via computer-readable instructions to (i) identify building objects within a three-dimensional model of the building envelope and (ii) determine envelope properties and location of thermal anomalies in the three-dimensional model.

2. The system of claim 1, wherein the computer vision and signal processing system are performed in a processing pipeline in real-time.

3. The system of claim 1, wherein the unmanned aerial system is configured via second computer-readable instructions with a preliminary flight path for a given building structure and then with instructions to perform a detailed close-up inspection flight of an identified location of thermal anomalies.

4. The system of claim 1, further comprising:
an analysis system configured to perform a photogrammetry analysis operation to generate the three-dimensional model of the building envelope.

5. The system of claim 4, wherein the analysis system is configured to register identified defects to the three-dimensional model.

6. The system of claim 1, wherein RGB image data of the one or more first visual sensors and IR image data of the one or more first visual sensors are combined by keypoint detection and matching.

7. The system of claim 4, wherein the aligned image data of the one or more first visual sensors are mapped, via a homographic transformation operation, to the three-dimensional model of the building envelope.

8. The system of claim 1, wherein the identified building objects are represented as coordinate data.

9. The system of claim 7, wherein the thermal anomalies are represented as coordinate data.

10. The system of claim 4, wherein the analysis system is configured to (i) generate polygonal objects of the coordinate data of the identified building objects and the thermal anomalies and (ii) register the polygonal objects to the three-dimensional model.

11. The system of claim 10, wherein the polygonal objects are assigned a thermal characteristic parameter different from that of the three-dimensional model.

12. A method for exterior building envelope inspection comprising:
obtaining, by a processor, image data of an unmanned aerial system, wherein the image data are acquired from one or more first visual sensors of the unmanned aerial system;
detecting objects, including doors and windows, within the obtained image data;
identifying the detected objects via one or more classification operation; determining areas of the detected objects via a second classification operation;
categorizing, via a search model, anomalies in the image data from the first visual sensors; and
combining data of the categorized anomalies with data of the detected objects to quantify each anomaly's probability and class type, wherein the combined data are assigned a thermal characteristic parameter different from that of a three-dimensional model of the building envelope.

13. The method of claim 12, further comprising:
outputting an inspection report for exterior building envelope inspection.

14. The method of claim 12, wherein the image data of the one or more first visual sensors are combined by keypoint detection and matching.

15. The method of claim 14, wherein the aligned image data of the one or more first visual sensors are mapped, via a homographic transformation operation, to the three-dimensional model of the building envelope.

16. The method of claim 15, wherein the three-dimensional model of the building envelope is generated via a photogrammetry operation.

17. The method of claim 12, wherein the image data from the one or more first visual sensors are obtained via a first flight path of the unmanned aerial system, the unmanned aerial system comprising one or more second sensors for multi-spectral imaging to maintains a distance to the building envelope according to the first flight path.

18. The method of claim 17, wherein the image data from one or more first visual sensors are additionally obtained via a second flight path of the unmanned aerial system that maintains a constant elevation in a strip path flight path.

19. A non-transitory computer readable medium having instructions thereon, wherein execution of the instructions by a processor cause the processor to:
obtain image data of an unmanned aerial system, wherein the image data are acquired from one or more first visual sensors of the unmanned aerial system;
detect objects, including doors and windows, within the obtained image data;
identify the detected objects via one or more classification operation;
determine areas of the detected objects via a second classification operation;
categorize, via a search model, anomalies in the image data from the first visual sensors; and
combine data of the categorized anomalies with data of the detected objects to quantify each anomaly's probability and class type, wherein the combined data are assigned a thermal characteristic parameter different from that of a three-dimensional model of the building envelope.

20. The computer readable medium of claim 19, wherein the execution of the instructions by the processor further cause the processor to:
output an inspection report for exterior building envelope inspection.

21. The computer readable medium of claim 19, wherein the image data of the one or more first visual sensors are combined by keypoint detection and matching.

22. The computer readable medium of claim 21, wherein the aligned image data of the one or more first visual sensors are mapped, via a homographic transformation operation, to the three-dimensional model of the building envelope.

23. The computer readable medium of claim 22, wherein the three-dimensional model of the building envelope is generated via a photogrammetry operation.

24. The computer readable medium of claim 19, wherein the image data from the one or more first visual sensors are obtained via a first flight path of the unmanned aerial system, the unmanned aerial system comprising one or more second sensors for multi-spectral imaging to maintains a distance to the building envelope according to the first flight path.

25. The method of claim 24, wherein the image data from one or more first visual sensors are additionally obtained via a second flight path of the unmanned aerial system that maintains a constant elevation in a strip path flight path.
